(19) United States
(12) Patent Application Publication
(10) Pub. No.: US 2019/0308545 A1
(43) Pub. Date: Oct. 10, 2019

(54) MOBILE SALON VEHICLE

(71) Applicant: BEAUTY ON WHEELS, INC., North Hollywood, CA (US)

(72) Inventors: Mihran Tagvoian, Glendale, CA (US); Tatevik Gevorgyn, Glendale, CA (US); Stepan Aleksanyan, Glendale, CA (US); Grant Atikyan, North Hollywood, CA (US)

(21) Appl. No.: 16/376,946

(22) Filed: Apr. 5, 2019

Related U.S. Application Data
(60) Provisional application No. 62/653,531, filed on Apr. 5, 2018.

(51) Int. Cl. B60P 3/025; B60R 15/02; B60R 15/04

(52) U.S. Cl. CPC B60P 3/025; A45D 44/00; B60R 15/04; B60R 15/02

(57) ABSTRACT

A mobile salon vehicle includes a vanity chair bolted to a floor of the interior of vehicle, the vanity chair configured to provide seating for a client. The mobile salon vehicle also includes a plumbing system to provide water for assemblies and components of the mobile salon and to transfer used water to one or more water tanks. The mobile salon vehicle also includes a van engine, one or more batteries, a first alternator, a second alternator to convert energy from the van engine to transfer power to one or more batteries, and the one or more batteries to provide power to additional components and assemblies in the mobile salon vehicle.

### RELATED APPLICATION

This application claims priority to application Ser. No. 62/653,531, filed Apr. 5, 2018, entitled “Mobile Salon Vehicle,” the disclosure of which is hereby incorporated by reference.

### BACKGROUND OF THE INVENTION

Old brick and mortar stores are disappearing in many industries. Bookstores, large toy stores, and other retail stores are disappearing at ever increasing rates. Beauty shops and/or salons continue to exist in most strip malls, regular malls and standalone office buildings. However, a growing number of clients would like to have beauty services (e.g., hair, makeup and/or nails) performed at a location convenient to the client. In addition, these clients do not desire to have beauty equipment and/or supplies brought into their house in order to obtain this convenience.

### BRIEF DESCRIPTION OF THE DRAWINGS

FIG. 1A illustrates a view inside of a mobile salon vehicle with a side removed according to some embodiments;

FIG. 1B illustrates a schematic view of a back portion of a salon area according to some embodiments;

FIG. 1C illustrates a schematic view of a front wall of a waiting area according to some embodiments;

FIG. 1D illustrates a view inside of a mobile salon vehicle with a side removed according to some embodiments;

FIG. 1E illustrates a schematic view of a back portion of a salon area according to some embodiments;

FIG. 2 illustrates a side mechanical view of a mobile salon vehicle according to embodiments;

FIG. 3 illustrates a top mechanical cut away view of a mobile salon vehicle according to some embodiments;

FIG. 4 illustrates an isometric view of a mobile salon vehicle according to some embodiments;

FIG. 5 illustrates a back view of a mobile salon vehicle according to some embodiments;

FIG. 6A illustrates a top cut-away view of a mobile salon vehicle according to some embodiments;

FIG. 6B illustrates a top cut-away view of a mobile salon vehicle according to some embodiments;

FIG. 7A illustrates an electrical block diagram of a mobile salon vehicle according to some embodiments;

FIG. 7B illustrates a block diagram of electronic devices located within a mobile salon vehicle according to some embodiments;

FIG. 7C illustrates an electrical block diagram including an additional switching assembly in a mobile salon vehicle according to embodiments.

FIG. 8 illustrates a plumbing block diagram of a mobile salon vehicle according to some embodiments;

FIG. 8A illustrates a plumbing block diagram of a mobile salon vehicle according to some embodiments;

FIG. 9 illustrates a block diagram of a mobile beauty salon software system according to some embodiments;

FIG. 10A illustrates a front view and a side view of a styling station according to some embodiments;

FIG. 10B illustrates a schematic view of a styling tool holder according to some embodiments;

FIG. 11A illustrates a front view of a vanity mirror storage organizer according to some embodiments; and

FIG. 11B illustrates a side view of a vanity mirror storage organizer according to some embodiments.

### DETAILED DESCRIPTION OF THE INVENTION

The foregoing, and other features and advantages of the described subject matter, will be apparent from the following, more particular description of the preferred embodiments of the claimed subject matter, the accompanying drawings, and the claims.

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

In some embodiments, a vehicle may provide salon services at convenient locations for customers or clients. In some embodiments, a vehicle may be mobile and may move from location to location. In some embodiments, a vehicle may comprise a light commercial van, (such as a Mercedes-Benz Sprinter van). In some embodiments, other vans or light commercial vehicles may be utilized. In some embodiments, a mobile salon vehicle may provide stations for providing nail or manicure services, hair cutting services, hair washing services, hair styling services, and/or makeup services. In some embodiments, a mobile salon vehicle may have a height of 107 inches, a length of 275 inches, a width of 96 inches and/or a wheel base of 171 inches. In some embodiments, a mobile salon vehicle may have a longer or shorter length, a longer or shorter height, and/or a longer or shorter wheel base, all depending upon what salon equipment is being utilized and/or what salon services are being offered and/or performed. In some embodiments, a mobile salon vehicle may have a shorter width and potentially a bigger width, although a width may be constrained by a width of a highway or street lane, since the mobile salon vehicle must be driven and operated on the road. In some embodiments, a mobile salon vehicle may be powered by diesel fuel. In alternative embodiments, a mobile salon vehicle may be powered by gasoline, a hydrogen gas-based fuel, an ethanol-based fuel, one or more rechargeable batteries (e.g., thus be an electric vehicle) and/or a combination thereof (e.g., hybrids). The embodiments described herein illustrate a unique combination of salon equipment and tools, as well as unique combination of electrical components and systems to provide power to the salon equipment and tools. The embodiments described herein illustrate a unique plumbing and/or water distribution system to minimize harm to an environment while at the same time providing clients with the comfort and services expected at a beauty salon. The embodiments described herein illustrate a unique electrical power system that obtains most of its power from the van or vehicle while the vehicle is in operation, or from the external shore power connection when plugged in, or from the combination of both (i.e. when vehicle is running and when vehicle is plugged to shore power). In some embodiments, a unique makeup and styling tool holder has been crated to surround a vanity mirror and provide easy and efficient access to the subject having beauty services performed. Advantages provided by the mobile beauty salon or mobile salon vehicle are decreased travel time (both ways) to receive beauty salon services, specialized and personalized beauty services being available at a convenient location, and/or an ability to have the salon beauty services provided in a private environment.

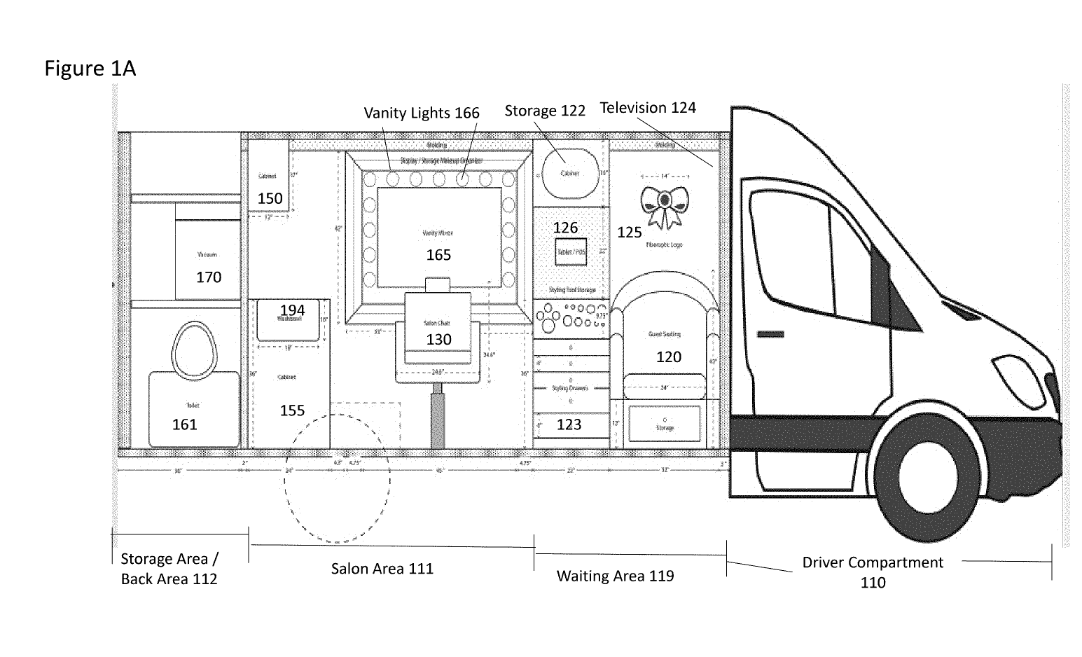

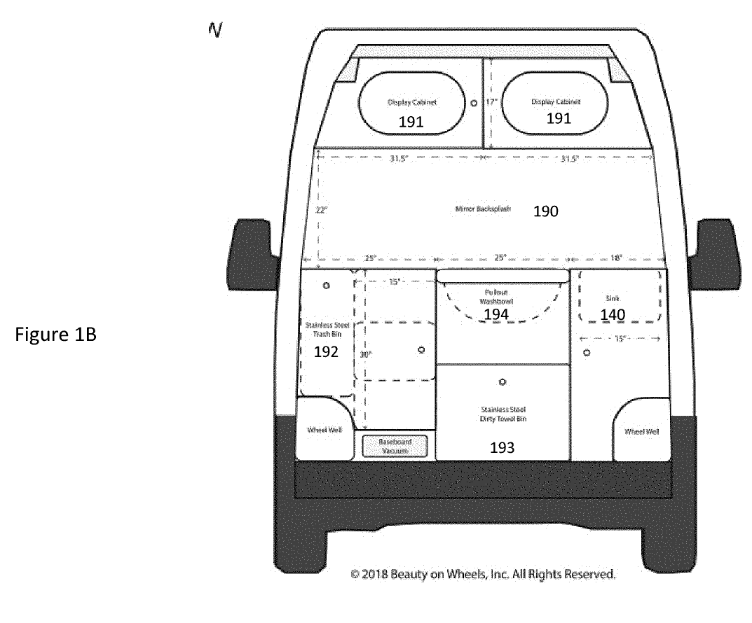

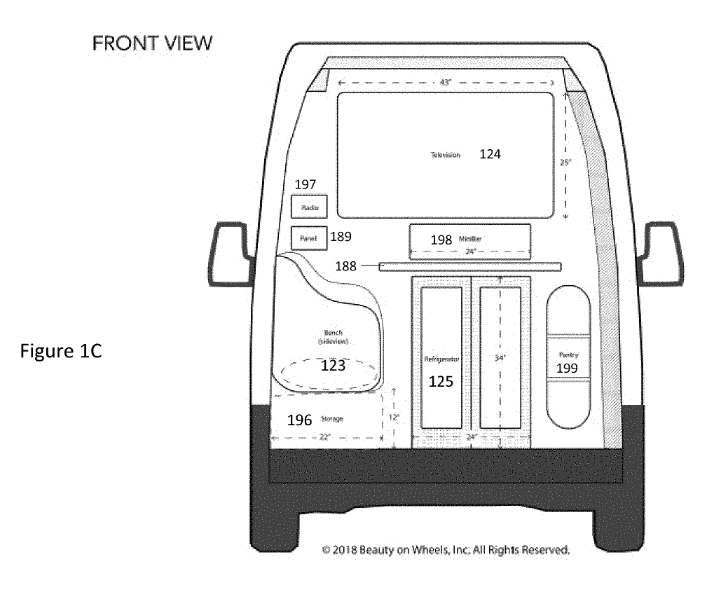

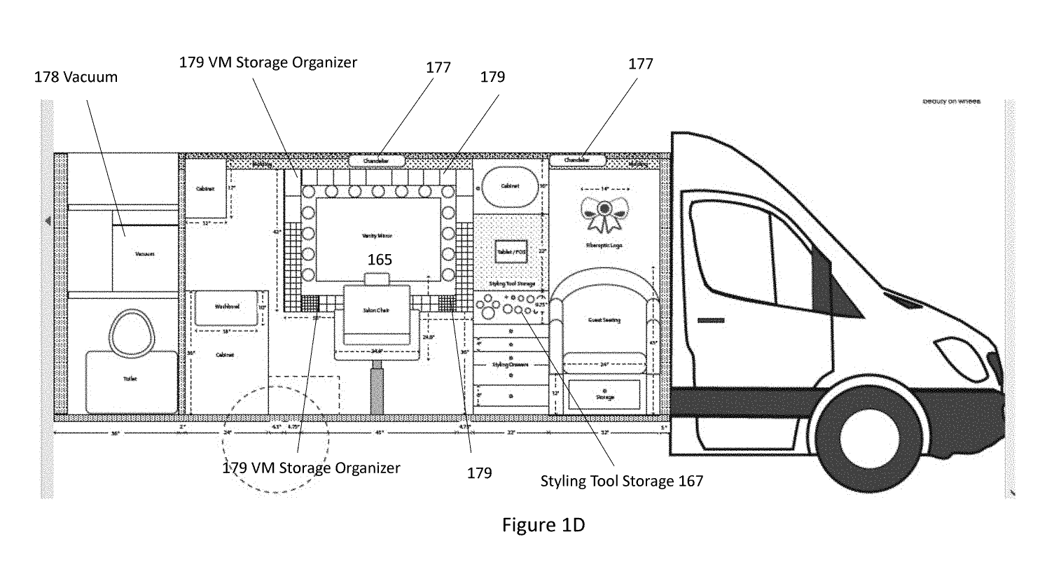

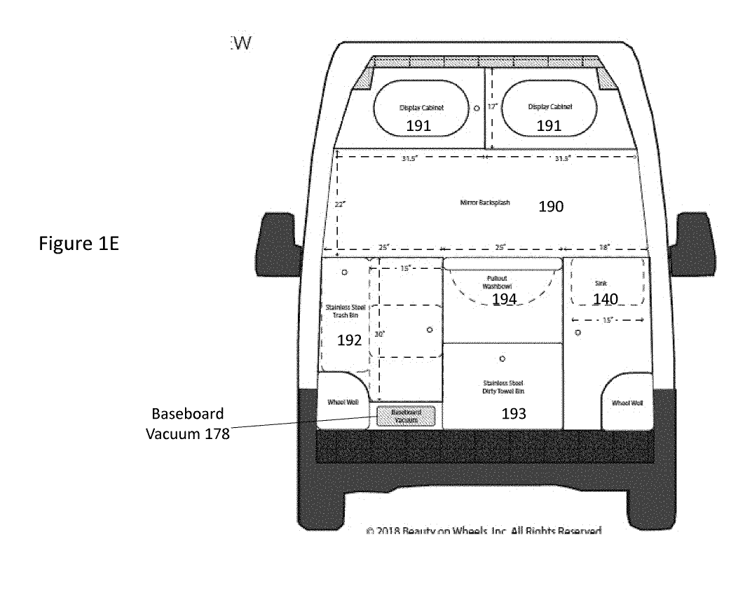

FIG. 1A illustrates a view inside of a mobile salon vehicle with a side removed according to embodiments. In some embodiments, a mobile salon vehicle 100 comprises a driver's compartment 110, a waiting area 119, a salon area 111 and a back area 112. In embodiments, a back area 112 may comprise a toilet 160 and a mechanical closet 170. In some embodiments, a back area 112 may be walled off from the salon area 111 and back area 112 for safety and/or hygiene purposes. In some embodiments, a back area 112 may be accessed from a rear door and not be accessible from the side door. In some embodiments, a waiting area 119 and a salon area 111 may share a same physical room (e.g., the waiting area 119 and the salon area 111 may not be walled off from each other). In some embodiments, a waiting area 119 may comprise a sitting assembly or furniture 120 (e.g., comprising, for example, a bench, chair and/or a couch, etc.), one or more storage compartments 122, one or more computing devices 126 and/or television devices 124 (not shown in FIG. 1). In some embodiments, a waiting area 119 may comprise a refrigerator or cooling device 125 (not shown in FIG. 1). In some embodiments, the refrigerator or cooling device 125 may be positioned along a wall of the waiting room that is adjacent and/or opposite to the back wall in the driver compartment 110. In some embodiments, this makes the refrigerator 125 facing the rear of the salon vehicle and easily accessible by clients in the waiting area 119 or the salon area 111. Current mobile salon vehicles do not have refrigerators due to the high energy consumption so this is a unique aspect of the present mobile salon vehicle. In some embodiments, a waiting area 119 may further comprise styling tool storage 123. In embodiments, styling tool storage 123 may comprise storage for curling irons, clippers, scissors, coloring tools, blow dryers and straight irons, as well as other beauty-related equipment. In some embodiments, the styling tool storage 123 may be drawers or shelfs. In some embodiments, a waiting area 119 may comprise an illumination assembly 125 (e.g., a lighting assembly including a Beauty on Wheels logo) to provide light and brightness to the waiting area 119 and/or a portion of the salon area 111. In some embodiments, the illumination assembly 125 may be a chandelier and may have a high wattage to brightly light the waiting area along with providing additional light into the salon area. In some embodiments, the illumination assembly 125 may be mounted and/or connected to ceiling and/or top surface of the waiting area in order to not move when the vehicle is moving. In some embodiments, the illumination assembly 125 may be mounted and/or connected to a side wall of the waiting area 119.

In some embodiments, a driver's compartment 110 may comprise one or more seats for a driver and/or a passenger. In some embodiments, a portion of a refrigerator or cooling device 125 may be installed in a driver's compartment. In some embodiments, the refrigerator or cooling device 125 may be completely installed in the waiting area 119. In some embodiments where a portion of the refrigerator or cooling device 125 is installed in the driver's compartment 119, a passenger seat may need to be removed in order to accommodate the refrigerator or cooling device 125. In some embodiments, the one or more refrigerators 125 may be a Whynter Fridge refrigerator. In embodiments, the one or more refrigerators 125 may run on AC power (e.g., from a power outlet or from an inverter). In some embodiments, a refrigerator 125 may be built-into a wall dividing the passenger section and the waiting area section. In embodiments, the one or more refrigerators 125 may have two or more temperature zones, the two or more temperature zones for storing different types of beverages (e.g., wine versus beer or soft drinks, which require different storage temperatures). In some embodiments, the one or more refrigerators 125 may require and/or utilize 100 Watts of power. In embodiments, a larger refrigerator 125 may be utilized because of the unique configuration of having a portion of the refrigerator being installed or positioned in the driver's compartment 110 of the mobile salon vehicle.

In some embodiments, a back area 112 may be accessible via a back door and may not be accessible from a salon area 111. In some embodiments, a toilet area 161 may comprise a toilet 160 and an exhaust fan (not shown in FIGS. 1A or 1B). In some embodiments, a toilet area 161 may be accessible via a rear door. In some embodiments, a toilet 160 may be a chemical toilet and may not need any plumbing for a water supply and/or waste disposal. In some embodiments, the toilet 161 may be a Thetford toilet with electric flush. In some embodiments, the toilet 161 may have its own power source, e.g., a battery. In some embodiments, a toilet 161 may have a removable waste tank which may be removed after each use or after a specific period of time or number of uses. In some embodiments, a toilet 161 may have a sensor and corresponding LED display indicating when a change of a waste tank is necessary. In some embodiments, a toilet 161 may have a transceiver to communicate with a computing device 126 in the mobile salon vehicle to indicate or notify an operator that the waste tank may need changing and/or that the toilet may be malfunctioning.

In some embodiments, a salon area 111 may comprise one or more bottom storage cabinets 155, one or more top storage cabinets 150, one or more mirrors 165, and one or more salon chairs 130. In some embodiments, a salon area 111 may further comprise one or more faucets 145 (not shown in FIG. 1A), one or more sinks 140 and/or one or more electrical supply areas. In embodiments, a salon area 111 may comprise one or more power outlets to supply electrical power to blow dryers, electric hair clippers, nail polish dryers or heaters, curling irons, flat irons and/or other beauty application accessories. In some embodiments, one or more power outlets may be GFCI outlets to provide adequate surge and grounding protection as well as to provide protection from shock when a liquid such as water is present near the electrical outlet. In some embodiments, a salon chair 130 may be a manually adjusted salon chair. In some embodiments, a salon chair 130 may further comprise an electric motor to move a salon chair to different positions based, at least in part, on received commands and/or signals. In some embodiments, a salon chair 130 may be a Tetris reclining chair. In some embodiments, a headrest of a salon chair 130 may be extendable and/or removable. In some embodiments, a reclining assembly may be a heavy-duty metallic system. In some embodiments, a salon chair may be made of a high-density memory foam covered with a soft vinyl covering. In some embodiments, a salon chair 130 may comprise a hydraulic pump to adjust a height. In some embodiments, a salon chair may comprise a footrest (e.g., a T-bar footrest) and/or may also comprise a base (which may be many different shapes). In some embodiments, a salon chair 130 may comprise a transceiver to receive commands from a computing device and/or remote control in a mobile salon vehicle to move to different positions. In some embodiments, a salon chair 130 may be mounted to a floor of the salon area 111 via connectors or fasteners in order to prevent the salon chair from moving.

In some embodiments, a salon area 111 may further comprise one or more vanity lights 166 and/or one or more lights or lighting assemblies 177 (not shown in FIG. 1A). In some embodiments, one or more vanity lights 166 may surround and/or encircle a mirror 165 (e.g., a vanity mirror). In embodiments, one or more recessed lights may provide light from a ceiling of a salon area 111 (either or both the waiting area and/or the beauty application area). In some embodiments, one or more lighting assemblies 177 may be mounted on a ceiling of a mobile salon van to provide bright lighting to the salon area 111 and/or the waiting area 119. In some embodiments, one or more lighting assemblies 177 may be a chandelier mounted to a ceiling of the salon area 111. In some embodiments, a mirror 165 may be a vanity mirror with a plurality of lights or light bulbs surrounding the vanity mirror 165. In embodiments, a vanity mirror 165 may be an Impressions vanity mirror. In embodiments, the vanity mirror 165 may comprise one or more mirror panels with a chrome base.

In embodiments, the salon area 111 may comprise one or more lights, chandeliers, pendants or lighting assemblies 177 (not shown in FIG. 1A). Lighting is extremely important in the mobile salon vehicle because a cosmetologist has to be able to see the customer and effects and/or impacts of certain colors, shades, cuts, etc. The salon area 111 and even the waiting area 177 may need to be very bright and provide light from many different angles and/or directions to assist the cosmetologist. In embodiments, a lighting assembly 177 may comprise an LED Pendant with clear crystals. In some embodiments, a lighting assembly may be a crystal oval shade paired with a chrome finish and a plurality of LEDs which is suspended from the ceiling. In some embodiments, a lighting assembly may utilize 24 LEDs (although more or less may be utilized). In some embodiments, the lighting assembly may generate 1600 lumens. In some embodiments, a lighting assembly 177 may generate and provide soft and ambient light.

In some embodiments, a lighting assembly 177 may be a Monteaux Lighting Crystal with a polished chrome LED semi-flush mount. In some embodiments, this lighting assembly has low power requirements and has a clear crystal to project and provide a nice and professional look even when turned off. In addition, in some embodiments, the lighting assemblies 176 and/or 177 may have low power requirements in order to conserve the electricity utilized in the mobile salon vehicle.

In embodiments, a salon area 111 may have a hardwood floor, a laminate floor and/or a tile floor. In embodiments, a floor material should be easily cleanable due to a potential of hair and beauty products landing and/or spilling onto a floor. In some embodiments, a laminate floor may be Noble Oak luxury vinyl plank flooring. In embodiments, the laminate floor may be waterproof, which is easy to clean and maintain. Because the laminate floor may waterproof, it reduces or eliminates warping, mold and mildew due to its waterproof construction. In some embodiments, a laminate floor may further comprise a commercial-grade wear layer to minimize wear and tear on the laminate floor.

In some embodiments, a salon area 111 may also have an acrylic side wall covering and/or a reflective side wall covering to provide a pleasant environment for customers and/or visitors of a mobile salon vehicle. In some embodiments, a waiting area 119 may have an acrylic side wall covering and/or a reflective side wall covering to provide a pleasant environment for customers and/or visitors of a mobile salon vehicle. In some embodiments, one or more side walls may have white acrylic sheets installed or mounted thereon. In some embodiments, one or more side walls may have insulation installed behind them to increase energy efficiency and to provide a comfortable environment within the mobile salon van by minimizing heat transfer to & from the van's exterior. In some embodiments, white acrylic sheets provide strength against external forces and/or scratches. In some embodiments, an acrylic side wall may be opaque and may block out light. In some embodiments, an acrylic side wall may be shatter resistant and may be a safe alternative to glass. Further, in some embodiments, an acrylic side wall may reflect interior light off and make an interior of a mobile salon van brighter and/or vibrant.

In some embodiments, a salon area 111 and/or a waiting area 119 may comprise a television and/or monitor 124. In some embodiments, a television, a monitor and/or display 124 may receive video and/or audio content from a satellite receiver, a CD or DVD players, and/or a streaming service over a global communications network. In some embodiments, a satellite receiver may be mounted on a roof of a mobile salon vehicle. In some embodiments, a television, a display and/or monitor 124 may be positioned or located on or near a wall next to or adjacent to a driver's compartment and may be facing the salon chair 130 in order to provide customer with different viewing options. In some embodiments, the television and/or monitor 124 may face the rear of mobile salon vehicle. In embodiments, a television, a display and/or a monitor 124 may be adjustable to change viewing angles. In embodiments, a television, a display and/or a monitor 124 may be recessed into a wall of waiting area 119 of a mobile salon vehicle. In embodiments, a salon area 111 and/or a waiting area 119 may comprise an audio receiver to receive music and/or audio files from a music or audio source (e.g., a mobile phone, a CD or DVD, a television, a mobile computing device and/or a streaming radio server). In some embodiments, a salon area 111 may further comprise one or more speakers (e.g., mounted in walls and/or ceilings) for playback of music and/or audio in the salon area 111, the waiting area 119 or both. In some embodiments, the one or more televisions 124 may be a Samsung 49 inch 4K Ultra HD Smart LED TV. In some embodiments, the one or more televisions 124 may be smart televisions, with integrated software applications and also web browsing applications, in order to interface with the computing device 126.

In some embodiments, a salon area may comprise a computing device 126. In some embodiments, a computing device 126 may be wall mounted, may be recessed into a wall or countertop, and/or may be positioned and/or located on a counter-top. In some embodiments, a computing device 126 may be a mobile computing device. In some embodiments, a computing device 116 may be operated as both a scheduling system, an inventory management system and/or a point-of-sale system for the cosmetologist and/or the franchisee. In some embodiments, a computing device 126 may be a laptop computer, a tablet computing device or a mobile computing device. In embodiments, a computing device 126 may comprise an iPad. In embodiments, one or more cosmetologists may utilize a computing device 126 (and associated computer-readable instructions executable by one or more processors—software) to keep track of services provided and/or products utilized and/or sold during provision of services. In some embodiments, one or more computing devices 126 may have one or more input devices such as bar code scanners, cameras, imaging devices, QR code scanners, and/or other scanning or captured devices. In some embodiments, more than one computing devices 126 may be present in a mobile salon vehicle. In embodiments, one or more computing devices 126 may communicate with and/or control operation (e.g., activation of, turning off, changing selections, etc.) of other electronic devices (audio system, television, refrigerator, vacuum cleaner, lighting assemblies, etc.) in the mobile salon vehicle. In some embodiments, a computing device 126 may be a Samsung Galaxy tablet computing device. In some embodiments, a computing device 126 may comprise 3GB RAM and/or a 32GB storage device. In some embodiments, the computing device may have additional FLASH memory. In some embodiments, a computing device 126 may comprise a 9.7 inch display and may utilize a AMOLED display protocol. In some embodiments, a computing device 126 may comprise one or more cameras or imaging devices and the mobile salon vehicle may have one or more imaging devices and/or cameras. In some embodiments, the camera or imaging device may comprise a 2.1 Megapixel camera and an 8 Megapixel camera. In some embodiments, the computing device may have one or more processors operating at approximately 2 Gigahertz. In embodiments, a computing device 126 may have a rechargeable battery (e.g., a Lithium Ion battery). In embodiments, the one or more computing devices 126 may interface with a mobile computing device (or other computing devices) of a cosmetologist, a franchisee, a customer, and/or Beauty on Wheels corporate offices. Each of the mobile computing devices 126 may comprise a client-server software application that interfaces with a Beauty on Wheels server computing device (e.g., one or more cloud-based servers or other external computing devices) assisting in running a Beauty on Wheels software application. In some embodiments, the computing device 126 may have one or more wireless communication transceivers to communicate with other mobile computing devices, routers, telephone switching devices, and/or server computing devices. In some embodiments, the one or more wireless communications transceivers in the computing device may be a personal area network (PAN) wireless communication transceiver (e.g., Bluetooth, Zigbee, Bluetooth Low Energy), wireless LAN communication transceivers (e.g., 802.11 transceivers or WiFi transceivers), and/or cellular communication transceivers (e.g., 3G, 4G and/or 5G-based transceivers).

In some embodiments, a mobile salon vehicle may comprise a mechanical closet 170. In some embodiments, a mobile computing device may comprise an electrical panel 171, a rechargeable power supply 172, one or more inverters 173, one or more vacuums and/or one or more water heaters 174. A mechanical closet is not shown in FIG. 1A as it is hidden by a wall of a back or storage area 112. In some embodiments, a mechanical closet 170 may located in a rear of a mobile salon vehicle 100 and may be accessible by opening of one of the rear doors of the mobile salon vehicle.

In some embodiments, one or more integrated vacuum cleaners may be a Shop-Vac Wet/Dry Vacuum 178. In embodiments, the one or more integrated vacuum cleaners 178 may be installed and/or mounted to a floor and/or a wall of a mechanical closet 170. In some embodiments, a hose of a vacuum cleaner may be inserted through a hole in a wall and/or a cabinet that is in the salon area 111 so that the vacuum hose may be utilized in the salon area 111 without the vacuum body being present in the salon area 111. In other words, one end of the hose is attached to the vacuum cleaner 178 while another end of the hose comes out of a hole in the floor or wall in order to be utilized in the salon area 111 or the waiting area. In some embodiments, this allows the vacuum cleaner to be mounted to a shelf or rack in the mechanical closet 170 and thus not be in the present of the client's in the salon area or the waiting area. This may reduce some of the noise generated by the vacuum cleaner 178. In some embodiments, the vacuum cleaner 178 may be detachable and/or on wheels and may be removed from the mechanical closet and may be taken into the salon area 111 for cleanup. In some embodiments, a cord length may be up to 10 feet (although longer lengths or shorter lengths may be utilized). In some embodiments, the vacuum cleaner 178 may have a tank and/or a tank drain. In embodiments, the tank may be plastic or stainless steel.

FIG. 1B illustrates a schematic view of a back portion of a salon area according to embodiments. In some embodiments, the mechanical closet and the toilet may have been eliminated to show a back portion of the salon area. In some embodiments, a back portion of a salon area 111 may comprise one or more sinks 140, one or more pullout washbowls 194, one or more towel bins 193, one or more trash bins 192, one or more mirrors 190 and/or mirror backsplashes, and/or one or more display cabinets 191. In some embodiments, one or more sinks 140 may be made of porcelain, composite material, and/or stainless steel. In some embodiments, one or more washbowls 194 may be made of porcelain, composite material, and/or stainless steel. In some embodiments, one or more washbowls 194 may be utilized for washing a client's hair, and/or coloring or dying a client's hair. In some embodiments, one or more towel bins 193 may be made of stainless steel or wood. In some embodiments, one or more trash bins 192 may be made of stainless steel or wood. In some embodiments, one or more towel bins 193 may be located directly below a pullout washbowl 194. In some embodiments, one or more mirror backsplashes 190 may be made of an acrylic, tile or wood. In some embodiments, one or more mirror backsplashes 190 may be located over one or more pullout washbowls 194, one or more sinks 140, and/or one or more towel bins 194. In some embodiments, the one or more display cabinets 191 may be located over the one or more mirror backsplashes 190.

FIG. 1E illustrates a schematic view of a back portion of a salon area according to some embodiment. FIG. 1E is another embodiment and illustrates positioning of a baseboard vacuum 178. In some embodiments, also, the one or more display cabinets may include a front surface that includes acrylic and/or glass, which provides a cosmetologist and/or customer to view products and/or tools stored inside

FIG. 1C illustrates a schematic view of a front wall of a waiting area according to embodiments. In some embodiments, the waiting area 119 may be viewed from a rear end of the vehicle in FIG. 1C. In some embodiments, a waiting area 119 may comprise one or more pantries 199 for storing food and/or drink supplies, one or more refrigerators or cooling assemblies 125, one or more storage cabinets 196, one or more benches, couches or seats 123, one or more operational panels 189, one or more radios 197, one or more televisions 124 and/or one or more mini bars 198, and one or more counters 188. In some embodiments, one or more storage cabinets 196 may be located under one or more benches 123 or one or more chairs or sofas. In some embodiments, one or more pantries 199 may be located on the right hand side of the back wall if looking at the back wall from the back of the mobile salon vehicle. In some embodiments, one or more pantries 199 will have a lower height than a height of one or more counters 188. In some embodiments, a refrigerator 125 may be located underneath one or more counters 188. In some embodiments, one or more counters 188 may be located underneath a minibar 198. In embodiments, a minibar 198 may be refrigerated or alternatively may only include dry items or high value items. In some embodiments, a minibar 198 may be integrated into the wall. In some embodiments, some of all of the refrigerator 125, the counter 188, the minibar 198 and/or the pantry 199 may be located beneath the one or more televisions 124 located on the wall facing the rear of the mobile salon vehicle. This is unique to have all of these components located on one wall in a seating or waiting area of a mobile salon van. In some embodiments, a minibar may be a surface and/or counter where food and/or beverages may be presented and/or displayed to clients and/or customers of a mobile salon vehicle. In embodiments, a radio 197 and/or an operational panel may be located above waist level and/or may be integrated into a wall. In embodiments, one or more operational panels 189 may allow control of operation of a television, a radio, and/or other electrical devices located within the mobile salon van. In some embodiments, the operational panels 189 may communicate with the other electrical components via wired connections, infrared wireless communications, personal area network (PAN) communications and/or Wi-Fi communications. In some embodiments, one or more operational panels 189 may contain a water level gauge/meter for the fresh water tank, a gray water level gauge/meter for the gray water tank, and a battery bank level gauge/meter for the battery bank's charge level.

FIG. 1D illustrates a view inside of a mobile salon vehicle with a side removed according to some embodiments. FIG. 1D is a side view of a similar configuration of the mobile salon vehicle shown in FIG. 1C with a few additional items added. In some embodiments, a back area of a mobile salon vehicle may comprise a vacuum 178 which is described in detail above. In embodiments, the vacuum 178 is not in view of customers or clients in the spa or salon area and is separated by a wall. In some embodiments, one or more lighting assemblies 177 (also described in detail below), may be chandeliers and may illuminate a salon area and/or a waiting area and/or may be mounted and/or connected to a ceiling of the salon area 111 or waiting area 119. In some embodiments, the one or more lighting assemblies 177 (e.g., chandeliers) may be hanging or installed on a ceiling of a mobile salon vehicle. In some embodiments, a vanity mirror cabinet and organizer 179 may be installed around a vanity mirror. In embodiments, the vanity mirror cabinet and organizer 179 is a unique apparatus because it surrounds the vanity mirror 165 and provides a cosmetologist (and thus a client) with access to beauty supplies (e.g., nail polish, makeup, foundation, etc.), towels, and beauty tools. In some embodiments, a vanity mirror cabinet organizer may allow a cosmetologist and/or client to see the products or tools to assist is selection of the products or tools. In embodiments, the vanity mirror cabinet and organizer 179 may be modifiable to fit a number of vanity mirrors, but is unique because no other vehicles have such a system for providing and displaying products and/or tools that is custom fit to the vanity mirror so that the cosmetologist or beauty professional has all products within arms distance or a small distance while he or she is delivering beauty services. In some embodiments, a styling tower or styling tower cabinet may comprise a cabinet or storage 122, a surface to connect to a tablet or POS computing device 126, a styling tool storage rack or holder and styling door drawers 123 for holding additional styling tools or products.

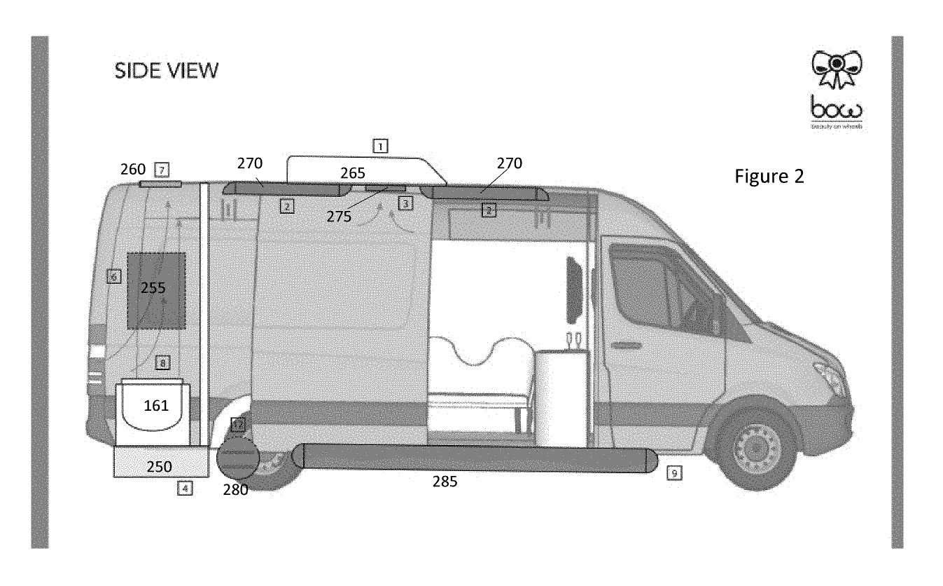

FIG. 2 illustrates a side mechanical view of a mobile salon vehicle according to embodiments. In some embodiments, a mobile salon vehicle 200 may comprise an electrical generator 250. In embodiments, an electrical generator 250 may be located on an under carriage of a mobile salon vehicle 200. In some embodiments, an electrical generator 250 may be an extra power source that can be utilized if there is a failure of the one or more batteries and a backup power source is required. This is a unique aspect of the mobile salon vehicle because other vehicles do not have a backup power system.

In some embodiments, a mobile salon vehicle 200 may comprise one or more electrical panels 255 in a mechanical closet. In embodiments, a mobile salon vehicle 200 may comprise an exhaust fan 260 to move air from the toilet area 160 and from around the toilet 161 to outside the mobile salon vehicle 200 as illustrated by the upward directed arrows in FIG. 2. In some embodiments, a mobile salon vehicle may comprise one or more air diffuser units 270 (e.g., ducts for passing air into an interior of a mobile salon vehicle), an air conditioning and/or heating unit 265, and one or more air or heating return vents 275. In some embodiments, the one or more air diffuser units or ducts 270 may flow the cool air or heated air into an interior of the mobile salon vehicle or a salon area 111 or waiting area 119 of the mobile salon vehicle 200. In embodiments, an air conditioning and/or heating unit 265 may be located and attached to a roof of a mobile salon vehicle 200. In some embodiments, the air conditioning and/or heating unit 265 may be installed on top of a roof of the mobile salon vehicle 200. In some embodiments, portions of the air conditioning and/or heating unit 265 may be located inside or on an underside of a roof with only a vent passed through the roof. In some embodiments, an air conditioning and/or heating unit may be a Coleman HVAC unit. In some embodiments, an air conditioning and/or heating unit may generate 13,500 BTUs. In some embodiments, an air conditioning and/or heating unit may generate between 7,500 to 17,000 BTUs.

In some embodiments, one or more air or heating ducts 270 may run along a top of a mobile salon vehicle or alternatively may be integrated into a ceiling of a mobile salon vehicle. In some embodiments, one or more ceilings may have insulation installed behind them to increase energy efficiency and to provide a comfortable environment within the mobile salon van by minimizing heat transfer to and from the van's exterior. In embodiments, a return vent 275 may be located on a ceiling or may be integrated into a ceiling of a mobile salon vehicle (e.g., in the salon area or the waiting area). In embodiments, a return vent 275 or an exhaust fan 260 may be a Fan-Tastic Vent and/or may fit a standard 14″ by 14″ opening. In embodiments, a return vent 275 or an exhaust fan 260 may have a reversible air flow and may have a low amp draw. In some embodiments, a return vent 275 may comprise a water or rain sensor that automatically closes a dome when rain or water is detected by the water or rain sensor. In some embodiments, the return vent 275 or an exhaust fan 260 may be activated by a switch or via an infrared remote (or a computer device, such as computing device 126). In some embodiments, a return vent 275 or an exhaust fan 260 may have an automatic variable speed that is thermostat activated or alternatively may have a manual speed with a plurality of settings (e.g., up to 13 or 15 settings). In some embodiments, a return vent 275 or an exhaust fan 260 may be powered by two wires, which supply a DC voltage (e.g., 12 Vs DC).

FIG. 2 also illustrates one potential placement of a water heater 280. In some embodiments, a mobile salon vehicle may comprise one or more water heaters 280. In some embodiments, one or more water heaters 280 may be located underneath an under carriage of a mobile salon vehicle 200. In some embodiments, a mobile salon vehicle 200 may comprise one or more portable water tanks 285. In some embodiments, one or more portable water tanks 285 may run from a back to a front of a mobile salon vehicle 200. In some embodiments, one or more portable water tanks 285 may provide a water supply for activities in the mobile salon vehicle 200 (e.g., such as washing and rinsing hair and providing water for faucets in the mobile salon vehicle.

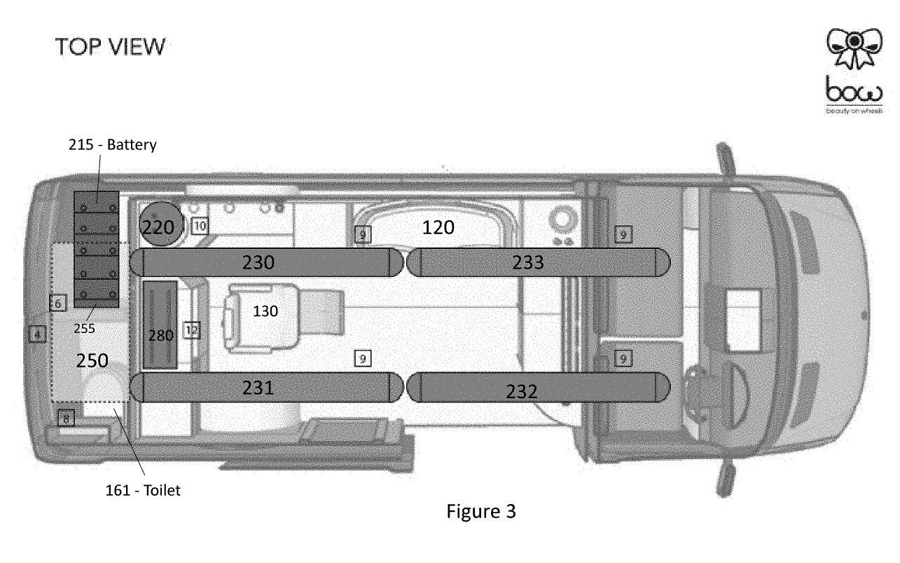

FIG. 3 illustrates a top mechanical cut away view of a mobile salon vehicle according to some embodiments. In some embodiments, a toilet area includes a portable toilet 161, which includes a toilet housing and a toilet bowl. In some embodiments, the back area (which may or may not include a mechanical closet) may comprise one or more electrical panels 255. In embodiments, a back area 112 may comprise one or more rechargeable power sources 215 (e.g., batteries), one or more hot water storage tanks 220, and one or more diesel water heaters 280. In some embodiments, a mobile device salon vehicle may comprise about four portable water tanks 230 231 232 or 233. In embodiments, a mobile device salon vehicle may comprise two portable water tanks or any number of water tanks utilized to provide potable water and to store waste water in the mobile salon vehicle. The number of and/or size of the water tanks may be based on use of water by the mobile salon vehicle. In some embodiments, the number of portable water tanks may be based on a number of factors (e.g., number of styling tools, number of sinks or washbowls, number of salon chairs, number of appointments expected in each visit, etc.). Similarly, the size of the portable water tanks may be dependent on a number of factors (e.g., number of sinks or washbowls, number of salon chairs, number of appointments, etc.)

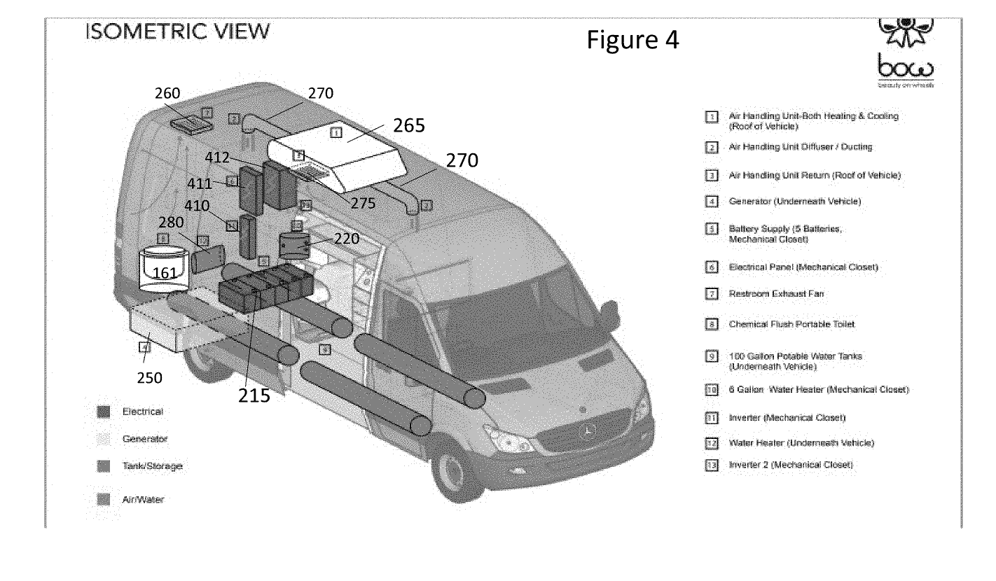

FIG. 4 illustrates an isometric view or perspective view of a mobile salon vehicle according to some embodiments. In some embodiments, a mobile salon van may comprise one or more AC/heating units 265, one or more heating/air ducts or piping 270, one or more return vents 275, one or more water heaters 220 for sinks and/or faucets hot water, one or more batteries (or rechargeable power sources) 215, and one or more water tanks 230 231 232 233 (both fresh water tanks and black/gray water tanks (e.g., black/gray water is water that has been utilized in operation of the mobile salon vehicle). In some embodiments, a mobile salon vehicle may comprise an exhaust fan 260, a chemical toilet 161, one or more generators 250, one or more inverters 410 and 412, one or more electrical panels 411, and one or more water heaters 280 underneath the mobile salon vehicle.

In some embodiments, as illustrated in FIG. 4, one or more batteries 215 may be located in a mechanical closet of a mobile salon vehicle. In some embodiments, the one or more batteries may be located in a bottom portion of a mechanical closet. In embodiments, one or more inverters 410 and 412 may also be located in a mechanical closet. In embodiments, one or more inverters 410 may be mounted on a wall of a mechanical closet of a mobile salon vehicle. In some embodiments, an inverter 412 may be located on a floor of a mechanical closet. In some embodiments, a mobile salon vehicle may have one inverter. In some embodiments, the one or more inverters may be the alternating current (AC) power source for the mobile salon vehicle (which may be 120 Volts AC and/or 240 Volts AC) and may provide the power for the electrical outlets into which a number of electrical components are attached. In some embodiments, the continuous power utilized by the mobile salon vehicle may be between, but not limited to, 3000 Watts to 7000 Watts continuous power. In some embodiments, the inverter may receive the power from the direct current (DC) power source (e.g., the batteries and/or the engine alternator). In some embodiments, the DC power source may provide one or more 12V DC, 24V DC, and/or 48V DC simultaneously for different electrical components. In some embodiments, the inverter may receive power from an external shore power hook-up. In embodiments, a second inverter may be utilized if the mobile salon vehicle's AC power load/requirements exceed a maximum continuous power output generated of the first inverter. In this embodiment, the AC power load and/or requirements may be split between the two inverters such that the AC load on each inverter does not exceed their respective maximum AC power capacity (e.g. second inverter may be 120V 2000 Watts and may power the HVAC air conditioning unit and the first inverter may be 120V 4000 Watts and may power the wet/dry vacuum, the GFCI outlets in the mobile salon vehicle, the television, the refrigerator, and/or any other electronic devices utilizing AC loads (or requiring AC power) within the mobile salon van.

In some embodiments, one or more hot water tanks 220 may be located on a floor of a mechanical closet. In some embodiments, one or more electrical panels 411 may be located and/or mounted on a wall of a mechanical closet. In some embodiments, one or more generators 250 (or other power backup systems) may be located underneath a mobile salon vehicle and may be mounted to an underside or an undercarriage of the mobile salon vehicle. In some embodiments, one or more portable water tanks 230 231 232 233 may be located underneath a mobile salon vehicle. In some embodiments, the one or more portable water tanks that are for clean water will be connected via piping to one or more water pumps, the one or more hot water heaters, and/or the one or more water sources (faucets). In some embodiments, by locating the one or more generators and the one or more portable water tanks underneath the mobile salon vehicle, space is conserved in the interior of the mobile salon vehicle. In addition, in some embodiments, the one or more generators and the one or more portable water tanks may be easily accessed, replaced and/or unloaded (in the case of water tanks) without accessing the interior of the mobile salon vehicle. In some embodiments, the one or more portable water tanks 230 231 232 233 that are used for black or gray water (or waste water) may be connected to drains of washbowls and/or sinks. In some embodiments, one or more chemical toilets 161 may be located in a toilet area or back portion of a mobile salon vehicle. In embodiments, an exhaust fan 260 may be located on a ceiling of a mobile salon vehicle (e.g., a bathroom area of a mobile salon vehicle).

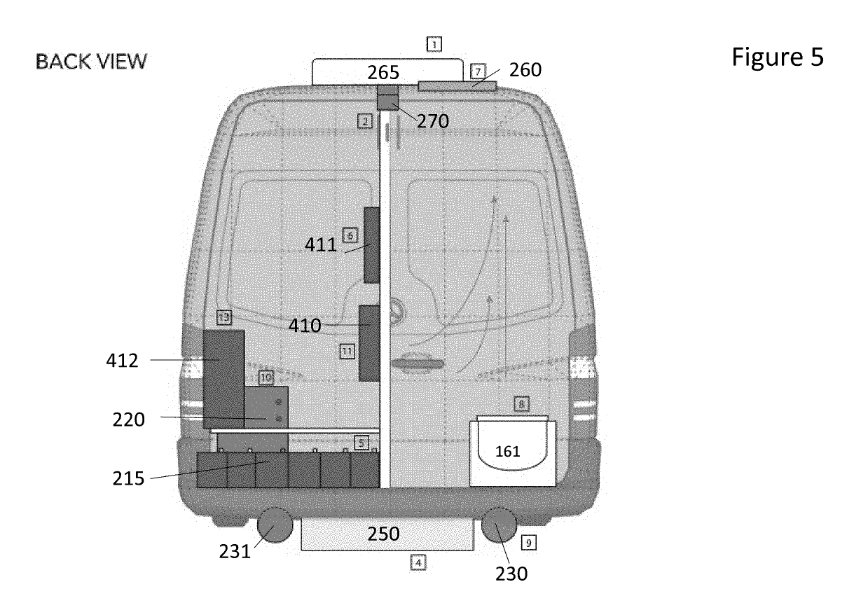

FIG. 5 illustrates a back view of a mobile salon vehicle according to some embodiments. In some embodiments, one or more heating/AC units 265 may be attached or positioned on top of a roof of a mobile salon vehicle. In some embodiments, an AC/heat return vent 260 may be integrated or partially integrated into a roof of a mobile salon vehicle, where a portion may be installed above a surface of the roof and another portion installed so that access to interior cabin may be provided to draw air in from the interior cabin. In some embodiments, the one or more heating/AC ducts 270 may be integrated into a roof and thus be able to provide cool air or heated air into the interior cabin of the mobile salon vehicle which includes the salon area 111 and/or the waiting area 119. In embodiments, one or more electrical panels 411 may be installed on an interior wall of a rear area near a center of the back of the mobile salon vehicle. In embodiments, one or more inverters 410 may be installed lower on an interior wall of a rear area (near a center of the back of the mobile salon vehicle). In some embodiments, the one or more batteries 215 may be installed in a bottom surface in a rear area of a mobile salon vehicle. In some embodiments, a larger inverter 412 may be installed on a floor surface in a mechanical closet. In some embodiments, one or more water heaters 220 may be installed on a bottom surface in a mechanical closet. In some embodiments, an integrated vacuum may be installed on a floor surface in a mechanical closet. In some embodiments, one or more generators 250 may be located on a bottom undercarriage of the mobile salon vehicle. Locating the electrical generation components in a rear area (or mechanical closet) that is separated from the salon area and/or the waiting area is an advantage over prior vehicles and also provides additional safety features.

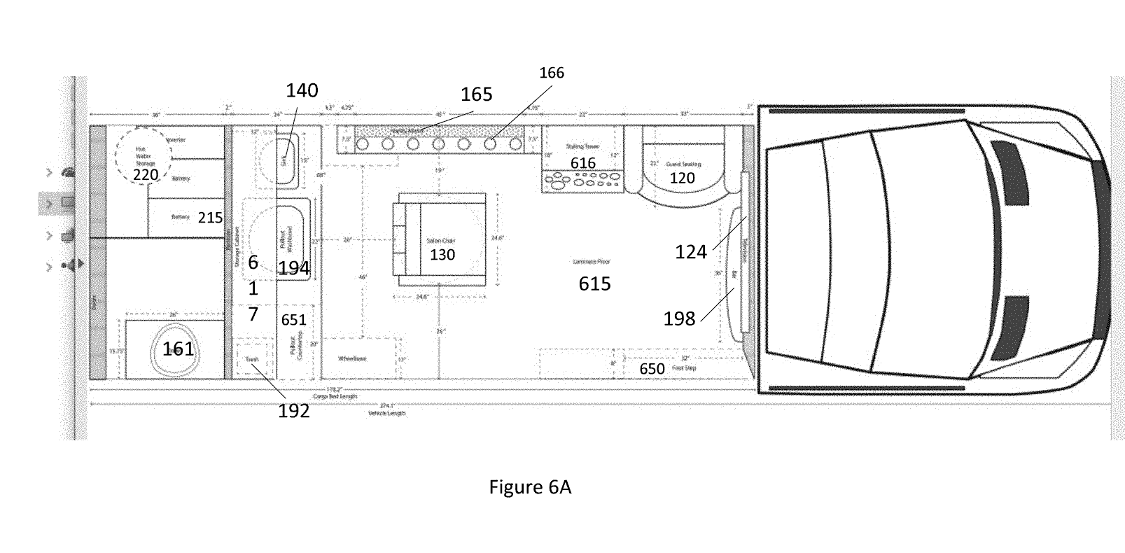

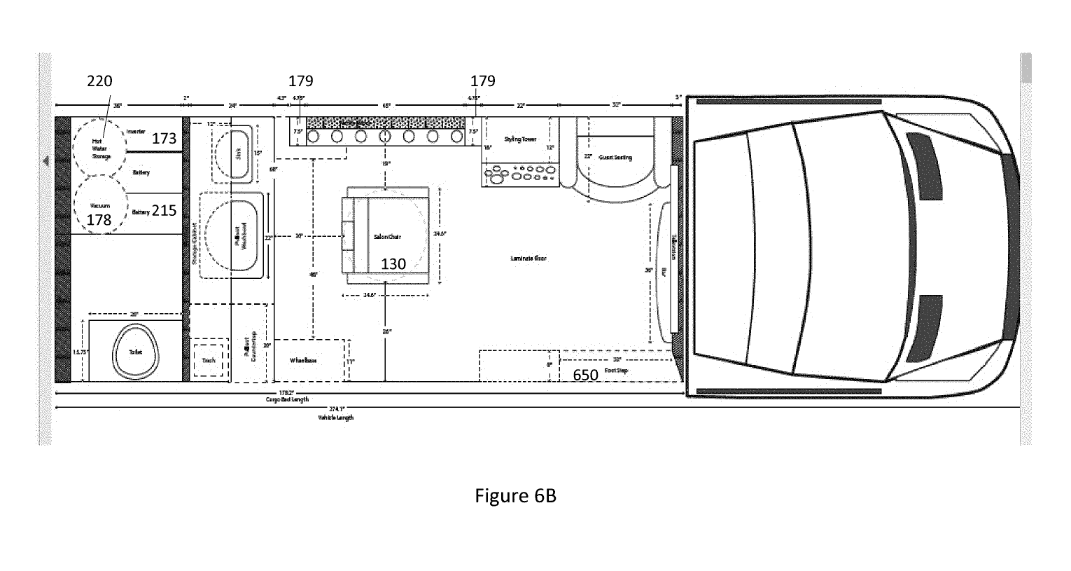

FIG. 6A illustrates a top cut-away view of a mobile salon vehicle according to some embodiments. The mobile salon vehicle 600 includes flooring 615 including laminate flooring, which is discussed in detail above. In some embodiments, a mobile salon vehicle 600 may comprise a styling table, tower and/or cabinet 616. In some embodiments, a salon area 111 of a mobile salon vehicle 600 may comprise a trash can 192 positioned near a rear of the salon area. In some embodiments, a salon area 111 of a mobile salon vehicle 600 may comprise a pullout countertop 651 that can be utilized to store products and/or beauty tools or to hold products or tools when beauty services are being provided to a client. In some embodiments, the pullout countertop 651 may be in a rear area of a salon area 111 and/or may be against a back wall of the salon area 111. In some embodiments, a salon area 111 of a mobile salon vehicle may comprise one or more storage cabinets 617. In some embodiments, the one or more storage cabinets 617 may be installed, positioned and/or mounted over the one or more sinks 140 and/or the pullout countertop and may have a height up to the beginning of the ceiling to maximize storage space.

In some embodiments, the mobile salon vehicle comprises a motorized step assembly 650. In embodiments, the motorized step assembly 650 may be an AMP Research PowerStep running board. In some embodiments, a motorized step assembly 650 may deploy automatically when a side door to the interior space of the mobile salon van (e.g., the waiting area or the salon area) is open. In some embodiments, a motorized step assembly 650 may withdraw or tuck completely underneath the mobile salon vehicle and retract flush against a vehicle body. In some embodiments, the motors in the motorized step assembly may be behind a waterproof housing. In embodiments, a motorized step assembly 650 may further comprise a lighting assembly to assist passengers in low light situations. FIG. 6A also illustrates the position of the bar 198 with respect to a television 124.

FIG. 6B illustrates a top cut-away view of a mobile salon vehicle with a portion of the roof eliminated over the rear area, the salon area 111 and/or the waiting area 119 according to some embodiments. In FIG. 6B, a vacuum 178 may be positioned in the back area of mobile salon vehicle. In some embodiments, a vacuum 178 may be located next to a hot water storage tank 220. In some embodiments, a vacuum 178 may be located next to and/or adjacent to one or more batteries 215 and/or one or more inverters 173. FIG. 6B also illustrates location and/or position of a vanity mirror display and storage organizer 179. In addition, FIG. 6B illustrates a location and/or position of a styling tower cabinet 616 and how a styling tool rack may extend out into a salon area and/or waiting area according to some embodiments.

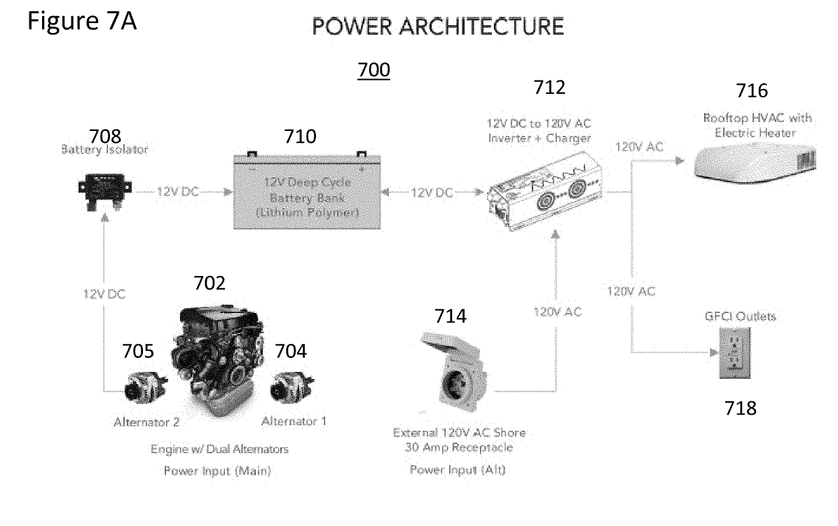

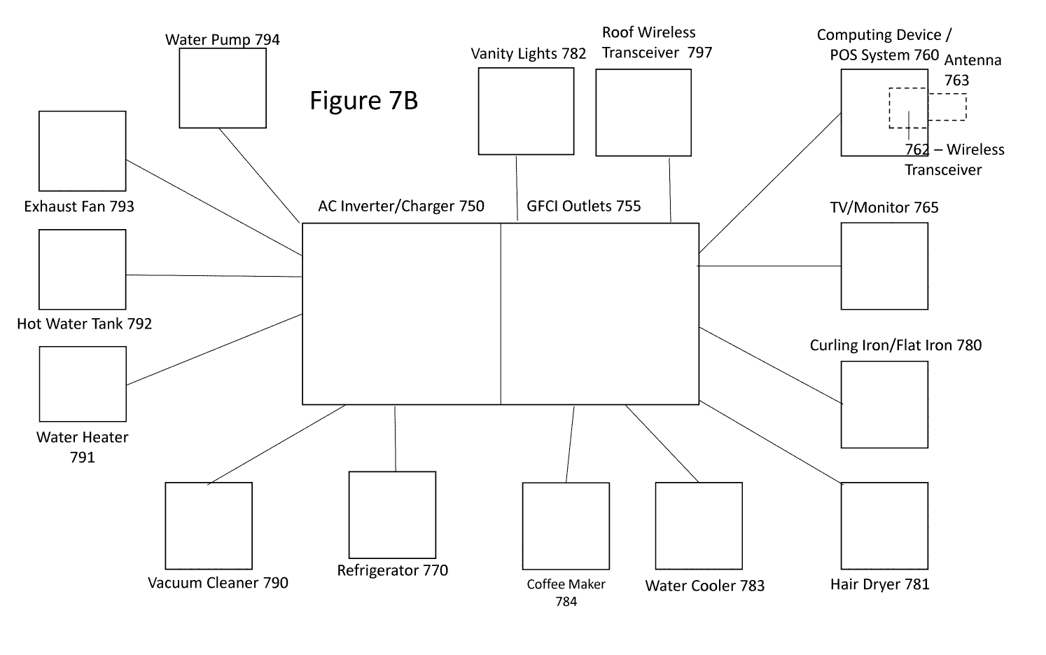

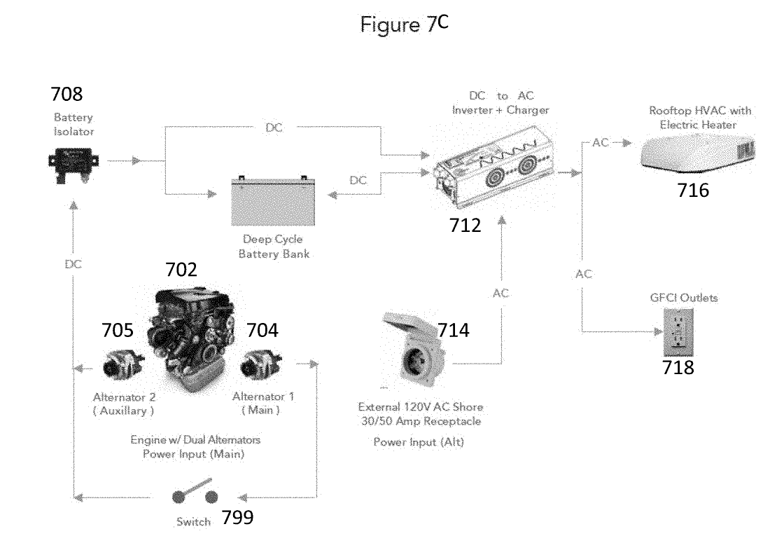

FIG. 7A illustrates an electrical block diagram of a mobile salon vehicle according to some embodiments. In some embodiments, an electrical system for a mobile salon vehicle 700 may comprise one or more engines 702, one or more alternators 704 and 705, one or more battery isolators 708 and/or one or more batteries (e.g., a battery bank comprising one or more rechargeable batteries) 710. In some embodiments, a mobile salon vehicle 700 may further comprise one or more DC to AC inverters and/or chargers 712, one or more AC power inputs 714, a rooftop AC/Heating Unit 716 and one or more GFCI outputs 718.

In embodiments, most mobile vehicles (e.g., cars and/or vans) may have an engine 702 and one alternator 704 (e.g., a first alternator or primary alternator). In some embodiments, a first alternator 704 may supply DC electric current and voltage to a vehicle's primary power system, components in a vehicle, such as vehicle batteries, vehicle control electronics, mechanical systems controllers, passenger cabin lights, a passenger cabin navigation system, passenger cabin display screen, and/or passenger cabin radio. In some embodiments, these components may be in the driver compartment and/or the passenger compartment 110. In some embodiments, vehicle batteries may also supply power to lights, vehicle computers, and/or other electro-mechanical components systems existing in the van (such as dash boards, etc.). In embodiments, a mobile salon vehicle 700 may comprise a second alternator 705 to assist in supplying electrical power to salon components of a mobile salon vehicle 700 (via electrical outlets) and outer power inputs. This is unique and new to the present mobile salon vehicle. This provides the advantage of providing additional voltage and current to devices and systems in salon area 111 and waiting area 119 of the mobile salon vehicle without taking away power from the existing van components. Also, the primary alternator 704 may also be connected via a switch 799 whenever even more power may be desired. This provides an additional advantage of having two alternators 704 and 705 power the components, devices and/or assemblies in the salon area 111, rear area and waiting area 119 and may not be present in other vehicles. FIG. 7C shows the switch 799 that may be coupled and/or connected to the primary alternator 704 in order to provide more power. In some embodiments, FIG. 7C also shows that a battery isolator 708 may provide DC power to the one or more battery banks 710 and/or directed to the one or more DC to AC inverter+charger 712. In some embodiments, a second alternator 705 may be located or positioned next to an engine 702 and may be located underneath a front hood of a mobile salon vehicle 700. As the motor is operational, the alternator converts mechanical energy generated by the one or more engines 702 into power (e.g., DC power). In some embodiments, a second alternator 705 (or additional alternators) may be coupled and/or connected via a power bus, cables and/or wires to one or more battery isolators 708. In embodiments, the one or more battery isolators 708 may be utilized to prevent current and/or voltage spikes, and/or electric noise generated by an engine 702 from interfering and/or reaching one or more rechargeable batteries (e.g., or battery banks) 710. In some embodiments, a second alternator 705 (or other additional alternators) may supply 12 volts DC to one or more battery isolators 708. In some embodiments, a second alternator 705 may be installed utilizing a mounting bracket and associated part. In some embodiments, a second alternator 705 (or additional alternators) may be a 280XP High Amp alternator (or any other high amp alternator) and may produce up to 200 amperes of current or more when an engine is idling. This electrical system also provides an advantage of charging the one or more rechargeable batteries 710 (or battery banks) when the engine is running, especially when the mobile salon vehicle is being driven from one location to another location. This is a significant advantage because the mobile salon vehicle may not have to stop to charge the batteries. In some embodiments, a second alternator 705 may be utilized when the one or more batteries (e.g., battery bank) 710 is a lithium-based battery. In some embodiments, the use of the second alternator 705 may provide power to operate a mobile salon vehicle indefinitely with or without having to recharge the battery bank 710. In some embodiments, the use of a second alternator may allow eight, sixteen or twenty four hours of operation without having the recharge the one or more battery banks 710.

In some embodiments, one or more battery isolators 708 may supply 12 volts DC to one or more battery banks 710 via power cables, wires or a power bus. In some embodiments, the one or more battery isolators 708 may be a Victron Intelligent Battery Combiner. In some embodiments, the one or more battery isolators 708 may connect batteries to either the primary and/or the second alternator 705 (or additional alternators) when an engine of the mobile salon vehicle is running and/or idling. In some embodiments, the one or more battery isolators 708 may disconnect the one or more batteries 710 from the second alternator 705 when the engine is not running. In some embodiments, the utilization of the one or more battery isolators 708 and the one or more battery banks 710 may be unique to mobile salon vehicles and provide additional safety in operating the vehicle.

In some embodiments, one or more battery banks 710 may be a 12V, 24V, or 48V deep-cycle battery bank. In some embodiments, a battery bank 710 may comprise five batteries although less or more batteries may be utilized in series and/or parallel. In some embodiments, one or more battery banks 710 may supply power to one or more inverters and/or chargers 712. Again, the use of the rechargeable batteries to provide power inside the salon area 111 and the waiting area 119 is a new and novel feature. In some embodiments, one or more battery banks 710 may be coupled or connected to one or more inverters and/or chargers 712 via power cables, wires and/or a power bus. In some embodiments, the battery bank (or one or more batteries) may be an Apex Deep Cycle Battery. In some embodiments, the one or more battery banks 710 may generate 12 Volts at 250 Amp hours. In some embodiments, the one or more battery banks 710 may be a sealed lead acid battery although other technologies may be utilized (e.g. AGM batteries, Lithium-Iron Phosphate batteries, etc.). In order for the high amperage devices and/or systems to operate at the same time (e.g., for example a hair dryer and an air conditioning unit) for a specified period of time (e.g., 2 hours to 4 hours), the one or more battery banks' capacity 710 may need to be at least 800 amp hours, 1000 amp hours typical.

In some embodiments, the one or more inverters and/or chargers 712 may be a 12 V DC (or 24V or 48V DC) to a 120V AC inverter and/or charger. In some embodiments, the one or more battery banks 410 may supply at least 400 amps of current to the one or more inverters or chargers 712. In some embodiments, the one or more inverters and/or chargers may be an Aims 4000 Watt 12 volt pure sine inverter charger. As discussed above, the mobile salon vehicle may utilize two or more inverters and/or chargers 712 to supply the AC load for the mobile salon vehicle. Although some devices are illustrated as being powered by inverters and/or chargers 712 and other devices are illustrated in FIG. 7A as being illustrated as being power by GFCI outlets 718, this is merely an illustration and some of the devices shown as being powered GFCI outlets 718 may be powered by inverters and chargers 712 and some of the devices shown as being powered by inverters and chargers 712 may be powered by GFCI outlets 718.

In embodiments, a mobile salon vehicle may need at least 20 to 50 amps of current at approximately 120 volts to provide power to the components and systems present in the mobile salon vehicle. In some embodiments, a mobile salon vehicle 700 may have one or more AC Shore power inputs 714 to provide additional necessary power to operate all systems and/or components in a mobile salon vehicle 700 if necessary (although the mobile salon vehicle may not need the AC power from the AC Shore power inputs). In some embodiments, an AC shore power input 714 may provide either 30 amps or 50 amps of current to one or more inverters and/or chargers 712 to assist in operation of systems and/or components in a mobile salon vehicle 700 and to charge its battery banks. In some embodiments, an AC shore power input system 714 may be coupled and/or connected to a household and/or business 120 Volt AC 30 amp power source. In some embodiments, the one or more inverters or chargers 712 may be connected to or coupled to a rooftop HVAC with electric heater 716 and provide power to the same. In some embodiments, the one or more inverters or chargers 712 may be connected to or coupled to a plurality of GFCI power outlets to provide power to various components, assemblies and systems in the mobile salon vehicle. In some embodiments, one or more household power outlets 718 may be GFI or GFCI power outlets into which electronic devices may be plugged into to receive power. In some embodiments, the electronic devices may be curling irons, hair dryers, televisions, point of sale terminals and/or water coolers.

FIG. 7B illustrates a block diagram of electronic devices located within a mobile salon vehicle according to embodiments. In some embodiments, a mobile salon vehicle may comprise one or more AC inverters/chargers 750 and/or one or more GFCI outlets 755. In some embodiments, one or more GFCI outlets 755 may receive power from one or more inverters/chargers 750. In some embodiments, one or more GFCI outlets may provide power to one or more vanity lights or a bank of vanity lights 782. In embodiments, one or more GFCI outlets 755 may provide power to one or computing devices 760. In embodiments, one or more computing devices 760 may be utilized as a POS system and may comprise one or more wireless transceivers (e.g., either WiFi transceivers and/or cellular transceivers (e.g., 4G or 5G cellular transceivers)). In some embodiments, one or more GFCI outlets 755 may provide power to one or more wireless transceivers 762 (e.g., WiFi transceivers or cellular transceivers). In some embodiments, one or more wireless transceivers 762 may be coupled and/or connected to antennas 763. In some embodiments, a mobile salon vehicle may comprise a rooftop wireless transceiver 797 which may also communicate with the one or more computing devices 760 inside the mobile salon vehicle. In some embodiments, a rooftop wireless transceiver 797 may be mounted to an outside surface of a roof of a mobile salon vehicle. In some embodiments, a rooftop wireless transceiver 797 may be able to communicate with external computing devices or electronic devices via one or more wireless communication protocols and/or other technologies (e.g., global positioning signals from GPS satellites). For example, in some embodiments, a rooftop wireless transceiver 797 may comprise a 3G, 4G, LTE, GPS, 802.11, personal area network (e.g., Bluetooth or Zigbee) and/or WiFi transceiver. In some embodiments, a rooftop wireless transceiver 797 may comprise one or more antennas. In some embodiments, a rooftop wireless transceiver 797 may comprise one or more connectors to couple to other devices. In some embodiments, a rooftop wireless transceiver 797 may comprise an external housing (which may be plastic) and the external housing may be waterproof in order to protect the wireless transceiver components. In some embodiments, a rooftop wireless transceiver 797 may comprise a through roof cable which means the rooftop wireless transceiver would receive power from either an outlet, a DC power source and/or an AC power source on top of or from within the mobile salon vehicle. In some embodiments, a cable providing power may also communicate data to one or more computing devices in the mobile salon vehicle. Other salons do not have a capability of being mobile and also providing a variety of wireless communication options to both beauty professionals and/or clients.

In some embodiments, the one or more GFCI outlets 755 may provide power to a television and/or a monitor 765. In some embodiments, one or more GFCI outlets 755 may provide power to a curling iron and/or flat iron 780. In some embodiments, one or more GFCI outlets 755 may provide power to a hair dryer 781. In some embodiments, one or more GFCI outlets 755 may provider power to a water cooler 783 and/or a coffee maker 784. These are only representative utilizations of the GFCI outlets and other beauty tools or appliances as well as consumer electronics and appliances may receive power from the GFCI outlets. In some embodiments, GFCI outlets may be used because of the use of water within the salon area and/or the close proximity of the waiting area. In some embodiments, this is another advantage of the mobile salon vehicle.

In some embodiments, one or more AC inverters and/or chargers 750 may provide power to a plurality of components and/or devices. In some embodiments, one or more AC inverters or chargers 750 may provide power to one or more refrigerators 770. In some embodiments, one or more AC inverters or chargers 750 may provide power to one or more vacuum cleaners 790. In some embodiments, one or more AC inverters or chargers 750 may provide power to one or more water heaters 491, although the water heaters may be diesel-powered (which would require a venting assembly), and/or may contain connections to an engine's coolant to heat the water with hot engine coolant. In some embodiments, one or more AC inverters or chargers may provide power to one or more hot water tanks 792. In some embodiments, one or more AC inverters or chargers 750 may provide power to one or more exhaust fans 793. In some embodiments, one or more AC inverters or chargers 750 may provide power to one or more water pumps 794. In addition, one or more AC inverters and/or chargers 750 may provide power to the one or more GFCI outlets 755.

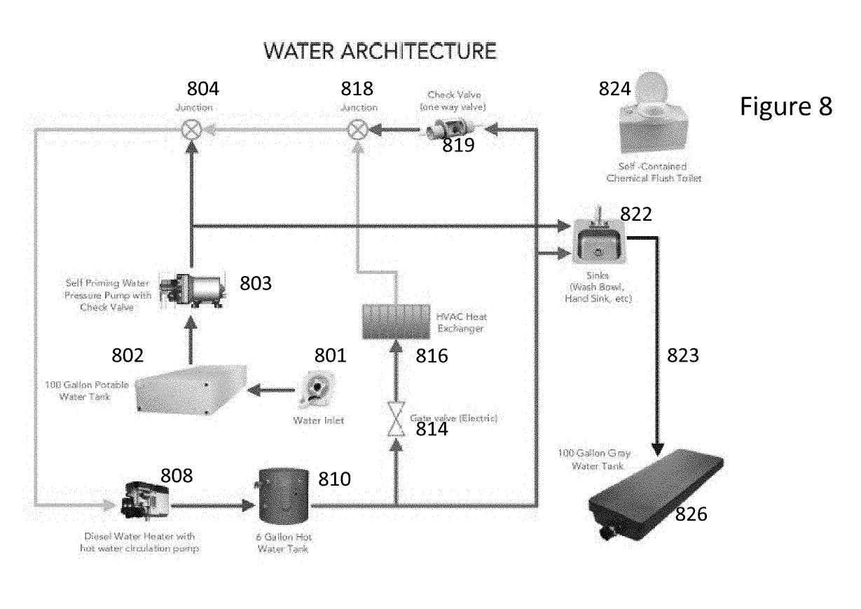

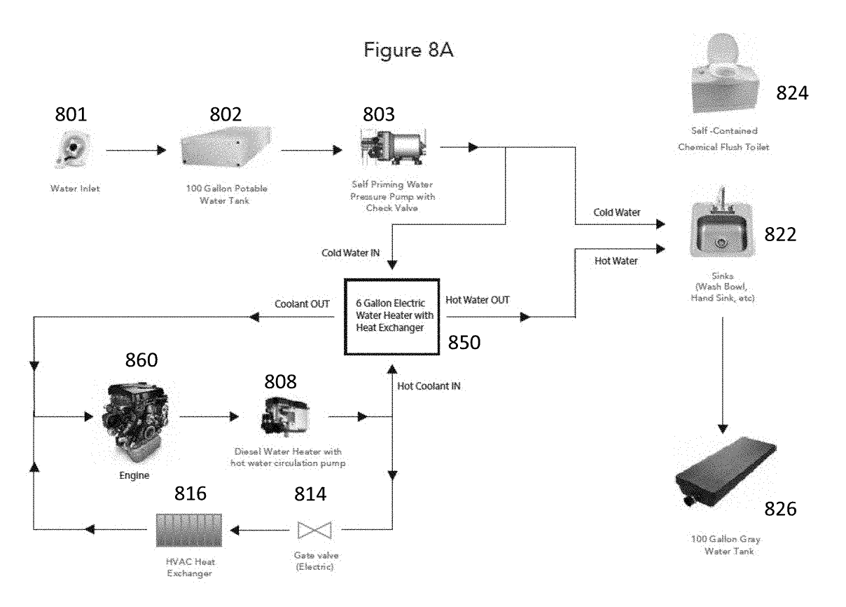

FIG. 8 illustrates a plumbing block diagram of a mobile salon vehicle according to some embodiments. In some embodiments, a plumbing system for a mobile salon vehicle 800 may comprise one or more water inlets 801, one or more portable water tanks 802, one or more water pumps 803, one or more first pipe junctions 804, one or more water heaters with pumps 808, and/or one or more hot water heater tanks 810. In some embodiments, a plumbing system for a mobile salon vehicle 800 may further comprise one or more gate valves 814, one or more HVAC heat exchangers 816, one or more second pipe junctions 518 and one or more check valves 820. In some embodiments, a plumbing system for a mobile salon vehicle may comprise one or more sinks 822 (including associated plumbing), one or more toilets 824 and/or one or more gray water or black water or sewage tanks 826. In some embodiments, the one or more portable water tanks 802 may be placed, mounted and/or attached underneath the chassis of the mobile salon vehicle 800. In some embodiments, the mobile salon vehicle 800 may be rectangular shaped or T-shaped. In some embodiments, the mobile salon vehicle 800 may two smaller tanks. In embodiments, the two smaller tanks may hold between 2 to 50 gallons of water or gray water. In some embodiments, one smaller tank may be for fresh water and the other smaller tank may be for gray water. In some embodiments, the one or more portable water tanks 802 and/or the smaller water tanks may include or comprise an overflow system.

In some embodiments, one or more water inlets 801 may provide an opening or valve to allow an external water source access to the one or more portable water tanks 802. In some embodiments, one or more portable water tanks 802 may comprise one or more valves with caps for filling one or more portable water tanks 802 with water after water has been utilized or used by devices and/or accessories in the mobile salon vehicle. In some embodiments, one or more portable water tanks 802 may have a valve, an inlet 801 and/or a cap on a side surface to allow a hose or other water supply to be connected and fill up the one or more portable water tanks 802 with water. In some embodiments, one or more portable water tanks 802 may be made of steel and/or aluminum. In some embodiments, one or more portable water tanks 802 may be welded to an underside of a body of a mobile sale vehicle. In some embodiments, one or more portable water tanks 802 may be attached via fasteners or via welds or other connectors to an underside of a body of a mobile salon vehicle. In some embodiments, one or more portable water tanks 802 and the values and/or caps may be located on sides of a mobile salon vehicle to allow an operator to have easy access for refilling the one or more portable water tanks 802 with water. In some embodiments, one or more portable water tanks may have a capacity of 100 gallons of water or may have a capacity of 200 gallons of water, although the capacity may be different for different mobile salon vehicle(s) or different configurations of a mobile salon vehicle. In some embodiments, one or more portable water tanks 802 may further comprise one or more water level sensors to determine a water level in the one or more portable water tanks 802. In some embodiments, the one or more water level sensors may be tied to the computing device to notify an operator, driver and/or beauty professional of low levels of water in the one or more portable water tanks.

In some embodiments, one or more portable water tanks 802 may be connected and/or coupled to one or more water pumps 803. In some embodiments, the one or more water pumps 803 may comprise a check valve to prevent water from going back to the one or more portable water tanks 802. In some embodiments, water may be provided by the one or more water pumps 803 to the cold water supply 821 of the one or more sinks 822. In embodiments, a metal pipe, a plastic pipe, and/or a composite pipe may connect one or more water pumps 803 to a cold water supply or faucet 820 of one or more sinks 822. In other words, one or more water pumps 803 may pump cold water out of one or more portable water tanks 802 and to a cold water supply or faucet 820 or one or more sinks 822. In some embodiments, one of the portable water tanks 802 may be utilized to supply and/or provide cold water to the one or more water pumps 803 and then to a cold water supply or pipe 820 of one or more sinks 822. In some embodiments, the one or more water pumps may be a Shurflow water pump that operates at 12 Volts DC and pumps up to 3 gallons per minute at approximately 55 PSI. In some embodiments, the one or more water pumps 803 may pump between 1 gallon to 10 gallons per minute. In some embodiments, the one or more water pumps 803 may comprise a built-in check valve.

In some embodiments, one of the portable water tanks 820 may be utilized to provide hot water to the one or more sinks through a different channel or supply as compared to the cold water. In some embodiments, one portable water tanks 802 may be connected on one or more water pumps 803 through one or more pipes. In embodiments, the one or more water pumps 803 may be connected to a pipe junction 804 via one or more pipes (metal, plastic or composite material). In embodiments, the pipe junction 804 may be connected to one or more water heaters with a circulation pump 808 through one or more pipes (e.g., metal, plastic or composite pipes). In embodiments, the one or more water heaters with a circulation pump 808 may be located on an underside on a mobile salon van 800 (e.g., a frame or under carriage). In embodiments, one or more water heaters with pumps 808 may be connected or coupled via piping to one or more hot water storage tanks 810. In some embodiments, one or more pipes may connect one or more water heaters with a pump 808 to provide or supply water to one or more hot water tanks 810 and one or more water heaters with a pump 808 may heat up the water in the one or more hot water tanks 810. In some embodiments, the one or more water heaters with a pump 808 may be diesel water heaters (although additional venting in case there is diesel fumes). In some embodiments, the one or more water heaters with a pump 808 may have a heating capacity of between 6,000 BTU/hours to 20,000 BTU/hours. In some embodiments, the one or more water heaters with a pump 808 may be a Webasto diesel water heater. In some embodiments, the one or more water heaters with a pump 808 may utilize an operating voltage of between 10 and 15 volts, and an operating current between 2 to 6 amps. In some embodiments, the one or more water heaters with a pump 808 may have a water flow of 2 gallons per minute at a pressure of 1.9 PSI. In some embodiments, if the water heater 808 is diesel powered, diesel fuel may need to loaded into the diesel pump. In embodiments, diesel fuel may need to be monitored on a continuous basis since it provides heat for the hot water, which is clearly needed if hair is being washed. In some embodiments, the water heater may have a sensor to determine if enough diesel fuel is present.

In some embodiments, one or more hot water tanks 810 may be six gallon, eight gallon or ten gallon water tanks. In some embodiments, a size of hot water tank may be dependent on configuration of mobile salon vehicle (e.g., if two sinks for hair washing and a HVAC and heating unit are being utilized, then a larger hot water heater may need to be utilized). In some embodiments, one or more hot water tanks 810 may not heat up water and the one or more hot water tanks 810 may receive the hot water pumped from the one or more water heater with pump 808. In some embodiments, one or more hot water tanks may contain an electric heating element to heat the water electrically. In some embodiments, one or more hot water tanks may contain a coolant heat exchanger to heat the water using hot engine coolant, where the engine coolant in turn may be heated by an engine 702 and/or a diesel water heater 808. In some embodiments, the one or more hot water tanks 810 may be a Rheem 6 gallon single element electric point-of-use water storage tank. In some embodiments, the one or more hot water tanks 810 may be a Kuuma 6 gallon electric water heater with hot coolant heat exchanger.

In some embodiments, piping may connect one or more hot water tanks 810 to hot water supply or faucet 821 of the one or more sinks 822. In some embodiments, a waste or drain pipe or channel 823 may be connected to a drain in one or more sinks and may transport water (after a hair wash or hand washing) through the drain pipe or channel 823 to one or more black water tanks, gray water tanks or used water tanks 826. In some embodiments, the one or more sinks or wash bowls 822 may be an E-mark round stainless steel brush bowl salon sink. In some embodiments, the one or more sink or wash bowls 822 may comprise hot and cold faucets, a receiver plate, a wall mounting bracket, a spray hose and a vacuum breaker. In some embodiments, the one or more sink or wash bowls 822 may comprise a water proof comfort-gel neck rest.

In some embodiments, one or more black water or gray water tanks 826 may have a valve and/or cap on a side surface to allow for easy draining or emptying of one or more black water or gray water tanks 826 as well as cleaning of one or more black or gray water tanks 826. In some embodiments, the one or more black water or gray water tanks 826 may be made of steel and/or aluminum. In some embodiments, the one or more black water or gray water tanks 826 may be welded to an underside of a body of a mobile sale vehicle. In embodiments, one or more black or gray water tanks 826 may be attached via fasteners to an underside of a body of a mobile salon vehicle. In some embodiments, one or more black or gray water tanks 826 and the values and/or caps may be located on sides of a mobile salon vehicle to allow an operator to have easy access for refilling the one or more portable water tanks 826 with water. In some embodiments, one or more portable water tanks may have a capacity of 100 gallons of water or may have a capacity of 200 gallons of water, although the capacity may be different for different mobile salon vehicle(s) or different configurations of a mobile salon vehicle. In some embodiments, one or more black or gray water tanks 826 may comprise one or more water level sensors to determine a water level in the one or more black or gray water tanks 826.

In embodiments, one or more hot water tanks 810 may supply hot water to a HVAC heat exchanger 816. In embodiments, one or more pipes and/or devices may couple one or more hot water tanks 810 to a one or more HVAC units. In embodiments, a hot water tank 810 may supply hot water to one or more gate valves 814. In embodiments, one or more gate valves 814 may be electric gate valves. In embodiments, one or more gate valves may allow or deny flow of water. In embodiments, one or more gate valves 814 may be coupled and/or connected to one or more HVAC heat exchangers 816 and may prevent water from returning back to the one or more hot water tanks. In embodiments, an electric gate vale 814 (where a valve opens & closes electrically) may allow or deny hot water flowing to a HVAC heat exchanger 816, which effectively enables or disables cabin air heating. In embodiments, if air heating is desired, the electric gate valve may open, otherwise the electric gate valve may stay closed by default.) In embodiments, the one or more HVAC heat changers 816 may be coupled to one or more HVAC units in order to allow the HVAC unit to supply heat to an inside compartment of a mobile salon van 800. In some embodiments, water output from the HVAC heat exchanger 816 may be supplied to a piping junction 818 and may be recycled into the hot water supply. In some embodiments, additional hot water not supplied to one or more sinks 822 may be supplied to the junction 818 through a check valve (one-way valve) 819. In some embodiments, the one check value 819 may prevent water from entering either supply of the one or more sinks 822 and instead flow into the pipe junction 818. In some embodiments, the check valve 819 may force hot water to come from hot water tank 810 to the sinks & prevents water flowing from 818 to the one or more sinks 822.

FIG. 8A illustrates a plumbing block diagram of a mobile salon vehicle according to some embodiments. A difference in FIG. 8A, as compared to is the use of hot coolant to heat the water for the sinks as well as to provide heat for the HVAC heat exchanger. In some embodiments, a water inlet 801 may provide water to a portable water tank 802 that may be attached to an underside of the mobile salon vehicle. In some embodiments, the water tank 802 may provide water to a water pump 803. In some embodiments, the water pump 803 may provide cold water to the electric water heater with heat exchanger 850. In some embodiments, the water pump 803 may provide cold water to the cold water inlet (or pipes) of the one or more sinks 822. In some embodiments, the waste water or gray water may be transferred from the one or more sinks 822 to the one or more gray water tanks 826. The use of coolant to provide heat is a new and unique feature for the mobile salon vehicle. In some embodiments, an engine 860 may be operated and may generate heat. In some embodiments, engine coolant may be transferred to a water heater 808 which may heat up the engine coolant to generate hot coolant. In some embodiments, the engine coolant may already be a warm or hot temperature, but the water heater 808 may cause the engine coolant to be a hotter temperature. In some embodiments, the diesel water heater 807 may transfer hot engine coolant to the water heater with heat exchanger 850 (which may be an electric water heater). In some embodiments, the hot coolant may heat up the water in the electric water heater with heat exchanger 850 and the hot water may be transferred via hot water piping and/or tubing to the hot water inlets or pipes of the one or more sinks 822. In some embodiments, the hot coolant out of the diesel water heater may transfer hot coolant through a valve or gate (which may be electric) 814 to the HVAC heat exchanger 816 (which provides power and heat to the heater and air conditioning unit). In some embodiments, the return coolant and/or water out of the water heater 850 and/or the HVAC heat exchanger 816 may then be input back to the engine 860. In some embodiments, the connections or couplings illustrated in FIGS. 8 and 8A may be piping, tubing, flex tubing and any other materials for transferring water or liquid.

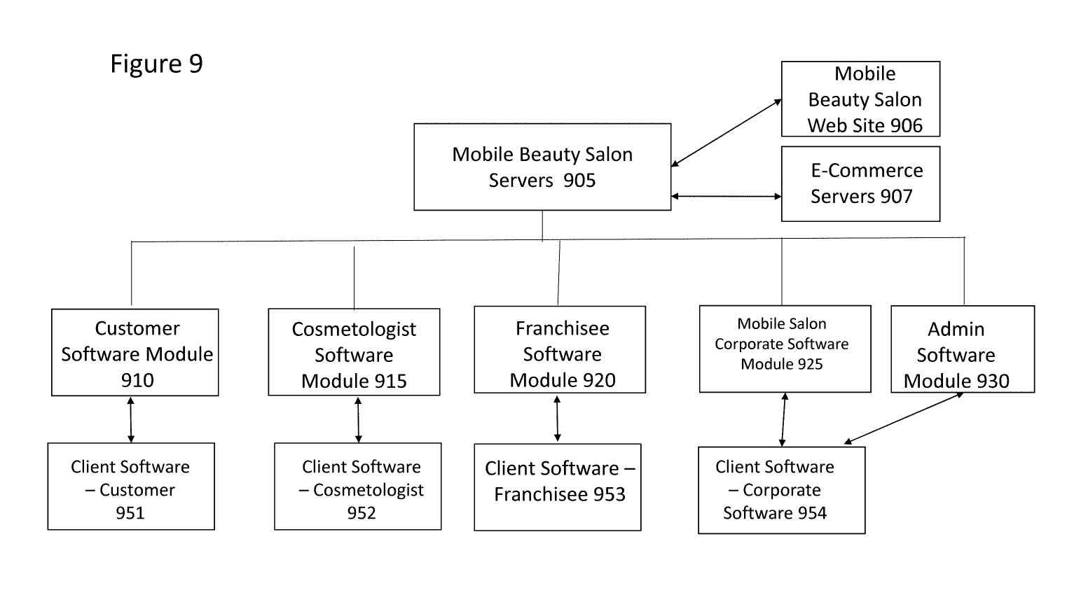

FIG. 9 illustrates a block diagram of a mobile beauty salon servers computing devices (e.g., mobile beauty salon application servers, database servers and/or mobile beauty salon servers) and associated client-server software modules according to embodiments. In some embodiments, mobile beauty salon servers may also communicate with a mobile beauty salon web site and/or an ecommerce server. In some embodiments, a mobile beauty salon web site may present landing pages (and other web pages) to cosmetologists, clients or customers, franchisees, owners and/or BOW personnel. In some embodiments, portions of the landing pages and other web pages may be stored and/or retrieved from the mobile beauty salon servers. In embodiments, an e-commerce server 907 may be operated by third parties and may provide the mobile beauty salon servers with the ability to allow clients and/or customer to purchase beauty or salon services and/or beauty products. In some embodiments, a mobile beauty salon software system may comprise mobile beauty salon servers 905, a mobile salon web site 906, a customer server software module 910, a cosmetologist server software module 915, a franchisee server software module 920, a mobile salon corporate server software module 925 and/or an administration server software module 930. In some embodiments, servers may comprise one or more memory devices, one or more processors, and/or computer-readable instructions executable by one or more processors that are stored in the one or more memory devices. In some embodiments, the software modules and the web site may be comprised computer-readable instructions executable by one or more processors.

In embodiments, a customer may have a computing device (e.g., a smartphone, tablet, laptop, or desktop computer) with a mobile salon software application installed thereon. This may be referred to as a customer client software module 951 which may communicate with customer server software module 910. In embodiments, the customer can schedule appointments, pay for services, look at cosmetologist's schedules, etc. via the customer client software module. In some embodiments, the software application may be computer-readable instructions executable by one or more processors of the mobile computing device.

In some embodiments, a cosmetologist may have a computing device (e.g., a smartphone, tablet, laptop, or desktop computer) with a mobile salon software application installed thereon, which may be referred to as a cosmetologist client software module 952. In embodiments, the cosmetologist client software module 952 may communicate with cosmetologist server software module 915. In embodiments, the cosmetologist may accept customer requests, generate reports, receive payments, schedule availability, etc. via the cosmetologist client software module 952. In some embodiments, the client and server software modules may comprise computer-readable instructions executable by one or more processors of the computing device and/or the server that are stored in one or more memory devices of the respective computing device and/or server.

In some embodiments, a franchisee may have a computing device (e.g., a smartphone, tablet, laptop, or desktop computer) with a mobile salon software application installed thereon. This may be referred to as a franchisee client software module 953 which may communicate with franchisee server software module 920. In embodiments, the franchisee can order supplies, track supplies, track cosmetologists, track customers, and/or track revenue via the franchisee client software module 953. In some embodiments, the franchisee client and server software modules may comprise computer-readable instructions executable by one or more processors of the computing device and/or the server that are stored in one or more memory devices of the respective computing device and/or server.

In some embodiments, a Beauty on Wheels employee or owner may have a computing device (e.g., a smartphone, tablet, laptop, or desktop computer) with a mobile salon software application installed thereon, which may be referred to as a corporate client software module 954. In embodiments, the corporate client software module 954 may communicate with mobile salon corporate server software module 925. In embodiments, the BOW employee or owner may track franchisee performance, cosmetologist performance, customer analytics and/or revenue analytics via the corporate client software module. Further, a corporate client software module 954 may communicate with mobile salon administration software module 930 in order to complete any administration functions for the mobile salon web server software. In some embodiments, the corporate client and server software modules may comprise computer-readable instructions executable by one or more processors of the computing device and/or the server that are stored in one or more memory devices of the respective computing device and/or server

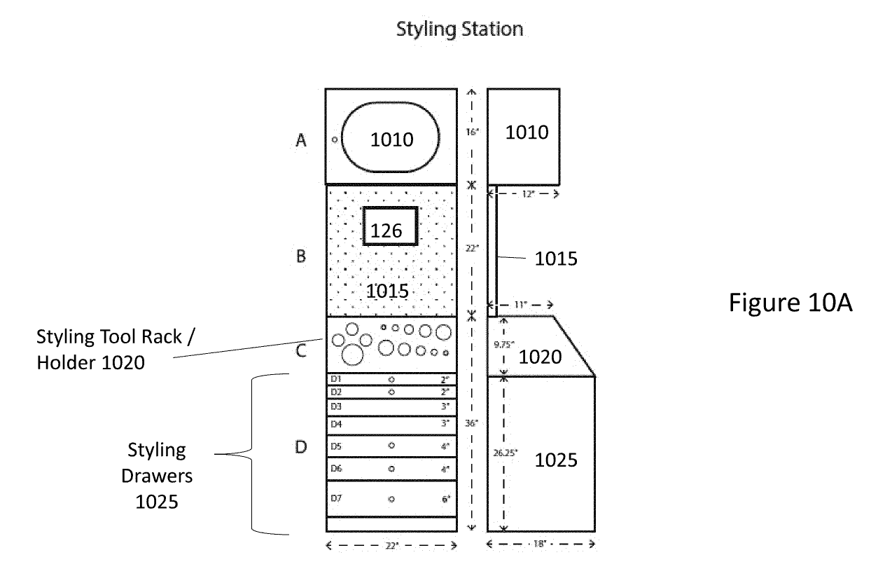

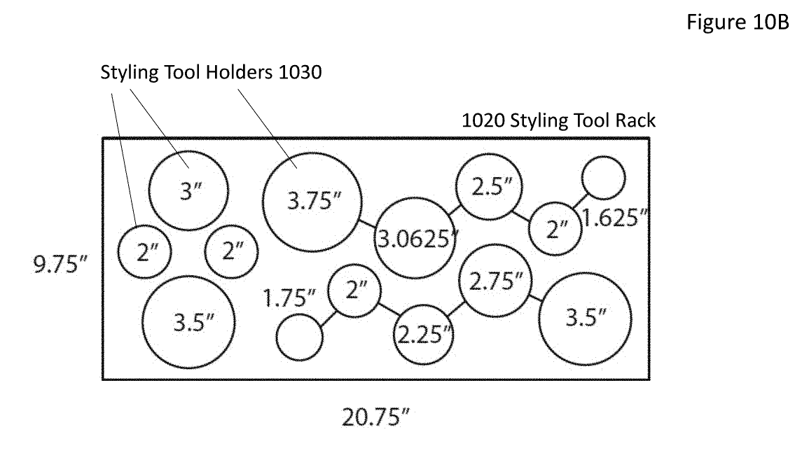

FIG. 10A illustrates a front view of a styling station according to embodiments and a side view of a styling station. In some embodiments, a styling station 1005 may comprise a storage cabinet 1010, a plate or wall 1015 for mounting and/or installing a tablet or computing device 1026, a styling tool holder and/or rack 1020, and/or one or more styling tool drawers 1025. In some embodiments, there may be seven styling tool drawers 1025 may have different widths (e.g., as shown in styling too drawers D1-D7). In embodiments, more or less styling tool drawers 1025 may be included in a styling station depending on size and height of mobile salon vehicle and needs of franchisee or cosmetologist. FIG. 10B illustrates a front view of a styling tool rack 1020 according to embodiments. In some embodiments, a styling tool rack or holder 1020 may comprise different diameter tubes 1030 (2 inch, 3.5 inch, 3.75 inch, etc.) to hold styling tools such as blow dryers, curling irons, straight irons, and/or other electronic beauty tools. In some embodiments, the different diameter tubes 1030 may have DC power outlets that the styling tools may receive power from. In this illustrative embodiment, the DC power outlet may be in a bottom part or back part of a tube. In some embodiments, a styling station 1005 may have a power bar in a back portion that may provide power to the DC power outlets and the power bar may receive DC power from power outlets in the mobile salon van. In some embodiments, a power bar may be mounted on a plate or wall 1015 to provide power to the electronic styling tools as well as to provide power to the tablet or POS computing device 126. These are significant advantages over existing products.

In some embodiments, a front face of a styling tool rack or holder 1020 may be angled between 30 to 75 degrees from a horizontal axis. By angling a front face of the styling tool rack or holder 1020, the styling tools are prevented from falling out of the styling tool rack or holder 1020. In some embodiments, the tubes 1030 in the styling tool rack or holder 1005 may be angled downward from front to back to provide further protection and/or security from the styling tools falling out of the one or more tubes 1030. In some embodiments, a styling tool station 1005 may be made of an acrylic material, a plastic material, a composite material, a metal material or a combination thereof. In some embodiments, a styling tool station 1005 may be made of a clear acrylic material. In some embodiments, a storage cabinet 1010 may include a front face with glass 1011 and an acrylic material 1012.

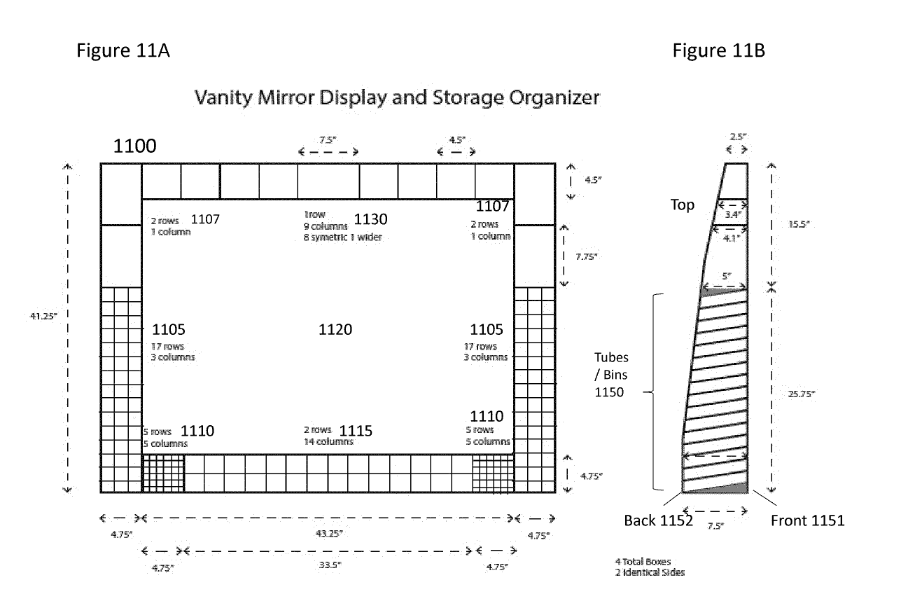

FIG. 11A illustrates a front view of a vanity mirror display and/or storage organizer according to some embodiments. FIG. 11 B illustrates a side view of a vanity mirror display and/or storage organizer according to some embodiments. In some embodiments, a vanity mirror storage organizer 1100 may include four sides (e.g., an upper side, a lower side, a left side and a right side) and surround a vanity mirror (which is located in space 1120 in FIG. 11A). In some embodiments, the vanity mirror storage organizer 1100 may be custom fit to a standard vanity mirror. In other words, a vanity mirror storage organizer may surround and/or be connected to an outside circumference of a vanity mirror. In some embodiments, a vanity mirror storage organizer 1100 may only include three sides (if a vanity mirror is triangular in shape), may include five sides (if a vanity mirror is pentagonal in shape) and/or may include six sides (if a vanity mirror is hexagonal in shape). In some embodiments, additional sides may also be used. In some embodiments, a vanity mirror may have a circular shape and a vanity mirror storage organizer 1100 may also comprise a circular shape and be positioned and/or connected to an outer circumference of a vanity mirror in order to encompass the vanity mirror storage organizer 1100. In some embodiments, a unique aspect of the vanity mirror storage organizer 1100 is that all sides or significant portions of the sides surround the vanity mirror. In some embodiments, a vanity mirror storage organizer 1100 may comprise a plurality of tubes and/or bins and/or shelves where beauty products may be positioned, displayed or stored. This vanity mirror storage organizer allows for beauty products and tools to be easily accessible and is unlike anything available on the market.

In some embodiments, a vanity mirror storage organizer 1100 may be made of a clear acrylic material in order to allow viewing and/or presentation of the beauty supply and products. A clear and acrylic system may also be easily replaceable in the case of wear and tear. A clear acrylic storage organizer may also reflect and gather light rays and beams and add brightness to the mobile salon vehicle environment, which may be pleasant to the user. In some embodiments, clear acrylic tubes and/or bins and/or containers may be similar to drawers and may have handles in order to be pulled out easily. In some embodiments, clear acrylic tubes and/or bins and/or containers may have open faces to allow easy access to contents of the bins, tubes, containers and/or shelves. In some embodiments, clear acrylic tubes and/or bins and/or containers may have an open top surface, which may be covered by a top of a row or a side of a column of the vanity mirror storage organizer 1130.

In some embodiments, a vanity mirror storage organizer 1100 may include a top row 1130 include a number of bins or shelves. In some embodiments, a top row 1130 may include 9 columns (as illustrated in FIG. 11A) with 8 symmetric bins or shelves and 1 bin or shelve which may have a wider width. In some embodiments, a top row 1130 may include more than one row and lesser or more columns. In some embodiments, a left side and a right side may each have a section with two rows and one column 1107 for storage or display of beauty products and beauty supplies. In some embodiments, a left side and a right side may each have a section 1105 with up to 17 rows and 3 columns of bins or tubes to store and/or display beauty products. For example, these sections 1215 may store and/or display lipsticks, lip gloss, lip glass, mascara, although other beauty products may also be stored or displayed. In some embodiments, these sections 1105 may be able to accommodate beauty products with rounded tubes. In some embodiments, a bottom side of a vanity mirror storage organizer 1100 may include two areas 1110 with 5 rows and 5 columns of bins or tubes and another area 1115 with 2 rows and 14 columns of bins or shelves. In some embodiments, the two areas 1110 with 5 rows and 5 columns of bins and tubes may be utilized to display and/or store pencil shaped products like eye liners, and lip liners as well as other thin beauty products. In some embodiments, the area 1115 with 2 rows and 14 columns of bins and shelve may contain jars, tubes and creams of various sizes, as well as shampoo, conditioner, lotion or other beauty product bottles. In some embodiments, the two areas 1110 having bins or tubes with 5 rows and 5 columns and/or the areas 1105 having bins or tubes or containers with up to 17 rows and 3 columns 1105 may have the front of the tubes or bins or containers at a higher level at the front of the vanity mirror storage organizer as compared to the back of the vanity mirror storage organizer. In some embodiments, this is clearly shown in FIG. 11B where the tubes or bins 1150 are at a higher height or level at the front 1151 of the sides of the storage organizer 1100 as compared to the back 1152 of the sides of the storage organizer 1100. This allows any beauty products and/or beauty supplies to be secure during transport and/or to prevent the beauty products and/or beauty supplies to pop out of the tubes, containers and/or bins. In some embodiments, a cover material may be placed over a front of the vanity mirror storage organizer. In some embodiments, the cover material may be transparent as to allow display of any beauty products and/or supplies.

In embodiments, a front part 1151 of one of the sides of the vanity mirror storage organizer may be approximately 90 degree vertical and thus be straight up and down. In some embodiments, as illustrated in FIG. 11B, a bottom part of the tubes or bins 1150 may protrude out from the front part of a side. In some embodiments, a back part 1151 of one of the sides of the vanity mirror storage organizer may not be perfectly straight (as is illustrated in FIG. 11B), so that the depth is smaller at a higher height. In some embodiments, the depth of the vanity mirror storage organizer at the top of the vanity mirror storage organizer may be smaller because the back side of the vanity mirror storage organizer 1100 may be pressed up against a side of the van, which curves inward as it gets closer to the ceiling. In some embodiments, an acrylic siding or laminate siding may also curve inward and a depth of the back side 1152 of the vanity mirror storage organizer 1100 may need to be smaller in order to accommodate this curve. In some embodiments, a vanity mirror storage organizer 1100 may be fastened to a side wall of a mobile salon vehicle and/or may be connected and/or fastened to a bottom or floor of a mobile salon vehicle. In some embodiments, a vanity mirror storage organizer 1100 may be fastened to an acrylic or laminate side paneling of the mobile salon vehicle. In some embodiments, a vanity mirror storage organizer may be coupled or connected to a vanity mirror. In some embodiments, the vanity mirror storage organizer may be a standalone apparatus that is coupled or connected to a vanity mirror in other environments besides mobile salon vehicles. In such embodiments, a back of a vanity mirror storage organizer 1100 may be straight and not curved because it does not have to be adjacent to a curved side wall of a mobile salon vehicle.

A mobile salon vehicle may include a vanity chair bolted to a floor of the interior of vehicle, the vanity chair configured to provide seating for a client; a plumbing system to provide water for assemblies and components of the mobile salon and to transfer used water to one or more water tanks; a van engine; one or more batteries; a first alternator; a second alternator to convert energy from the van engine to transfer power to one or more batteries, and the one or more batteries to provide power to additional components and assemblies in the mobile salon vehicle. In some embodiments, the mobile salon vehicle further includes a refrigerator to cool drinks for clients, the refrigerator to receive power from the one or more batteries. In some embodiments, the mobile salon vehicle further includes one or more overhead lighting assemblies, the one or more overhead lighting assemblies to receive power from the one or more batteries and the one or more overhead lighting assemblies to be attached to a ceiling of the interior of the salon area of the mobile salon. In some embodiments, the mobile salon vehicle includes a television for viewing by the client, the television mounted on an interior wall of the salon area and to receive power from the one or more batteries. In some embodiments, the mobile salon vehicle includes a heating and air conditioning system to provide heat or cool air to the viewing area and/or the salon area.

In some embodiments, the mobile salon vehicle includes one or more wireless communication transceivers and/or associated antennas, the one or more wireless communication transceivers and the one or more antennas to allow bidirectional communications between computing devices in the mobile salon vehicle and external computing devices. In some embodiments, the mobile salon vehicle includes one or more computing devices, the one or more computing devices being utilized as a point-of-sale (POS) terminal to monitor sales of beauty products or beauty services. In some embodiments, the mobile salon vehicle includes a vanity mirror. In some embodiments, the mobile salon vehicle includes a vanity mirror storage organizer, the vanity mirror storage organizer to be attached to edges of the vanity mirror to allow for easy access to beauty products or beauty tools. In some embodiments, the mobile salon vehicle includes a vacuum device, the vacuum device to clean the salon area and the waiting area. In some embodiments, the mobile salon vehicle includes a chemical toilet and a fan exhaust, the chemical toilet and the fan exhaust being located in a rear area of the mobile salon vehicle. In some embodiments, the mobile salon vehicle includes a motorized step assembly, the motorized step assembly to allow easy entry to the waiting area of the mobile salon vehicle.

In some embodiments, the mobile salon vehicle includes one or more water tanks for storing water to be utilized in providing beauty services to clients. In some embodiments, the mobile salon vehicle includes one or more black water tanks for storing water that has been used in providing beauty services to clients. In some embodiments, the plumbing system includes one or more clean water tanks and one or more water pumps, the one or more water pumps to transfer water to cold water input pipe for one or more sinks in the mobile salon vehicle. In some embodiments, the plumbing system includes one or more clean water tanks, one or more water pumps and one or more hot water heaters, the one or more water pumps to transfer water to the hot water heaters and the hot water heaters to heat the water. In some embodiments, the hot water heater is connected to one or more hot water tanks, the one or more hot water tanks to store the hot water produced by the hot water heater. In some embodiments, the water is transferred from the one or more hot water tanks to hot water pipes of the sinks of the mobile salon vehicle. In some embodiments, the mobile salon vehicle further includes a HVAC heat exchanger, the one or more hot water tanks to supply hot water to the HVAC heat exchanger to be utilized to operate the heating and air conditioning system. In some embodiments, the engine and a diesel water heater may heat up engine coolant to generate hot engine coolant which is used to provide hot water to one or more sinks in the mobile salon vehicle.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

For example, a “mobile communication device” may refer to a device or apparatus that comprises one or more processors, one or more memory devices, communication circuitry (such as wired or wireless communication transceivers), a display or screen, a power source, a power source interface, one or more sensor assemblies and/or one or more image sensors. In some embodiments, one or more image sensors may be one or more cameras, CCD arrays or similar devices. The mobile communication device may also comprise computer-readable instructions stored in the one or more memory devices that are executable by the one or more processors to perform certain features or functions as described herein. The mobile communications device may be portable and/or handheld and may be able to be moved easily from location to location. The terms smartphone, mobile phone, mobile computing device, portable computing device, mobile communications device and portable communications device may be utilized interchangeably through the specification. The mobile communication device may be a smartphone, a mobile phone, a tablet computing device, a laptop computing device, a PDA device, and/or wearable computing device (if aligned to fit and coupled to the corneal topography system).

In addition, one or more of the devices described herein may transform data, physical devices, and/or representations of physical devices from one form to another. Additionally, or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The above disclosure is sufficient to enable one of ordinary skill in the art to practice the invention, and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A mobile salon vehicle, comprising:
a vanity chair bolted to a floor of the interior of vehicle, the vanity chair configured to provide seating for a client;
a plumbing system to provide water for assemblies and components of the mobile salon and to transfer used water to one or more water tanks;
a van engine;
one or more batteries;
a first alternator;
a second alternator to convert energy from the van engine to transfer power to one or more batteries, and
the one or more batteries to provide power to additional components and assemblies in the mobile salon vehicle.

2. The mobile salon vehicle of claim 1, further comprising a refrigerator to cool drinks for clients, the refrigerator to receive power from the one or more batteries.

3. The mobile salon vehicle of claim 1, further comprising one or more overhead lighting assemblies, the one or more overhead lighting assemblies to receive power from the one or more batteries and the one or more overhead lighting assemblies to be attached to a ceiling of the interior of the salon area of the mobile salon.

4. The mobile salon vehicle of claim 1, further comprising a television for viewing by the client, the television mounted on an interior wall of the salon area and to receive power from the one or more batteries.

5. The mobile salon vehicle of claim 1, further comprising a heating and air conditioning system to provide heat or cool air to the viewing area and/or the salon area.

6. The mobile salon vehicle of claim 1, further comprising one or more wireless communication transceivers and/or associated antennas, the one or more wireless communication transceivers and the one or more antennas to allow bidirectional communications between computing devices in the mobile salon vehicle and external computing devices.

7. The mobile salon vehicle of claim 1, further comprising one or more computing devices, the one or more computing devices being utilized as a point-of-sale (POS) terminal to monitor sales of beauty products or beauty services.

8. The mobile salon vehicle of claim 1, further comprising a vanity mirror.

9. The mobile salon vehicle of claim 8, further comprising a vanity mirror storage organizer, the vanity mirror storage organizer to be attached to edges of the vanity mirror to allow for easy access to beauty products or beauty tools.

10. The mobile salon vehicle of claim 1, further comprising a vacuum device, the vacuum device to clean the salon area and the waiting area.

11. The mobile salon vehicle of claim 1, further comprising a chemical toilet and a fan exhaust, the chemical toilet and the fan exhaust being located in a rear area of the mobile salon vehicle.

12. The mobile salon vehicle of claim 1, further comprising a motorized step assembly, the motorized step assembly to allow easy entry to the waiting area of the mobile salon vehicle.

13. The mobile salon vehicle of claim 1, further comprising one or more water tanks for storing water to be utilized in providing beauty services to clients.

14. The mobile salon vehicle of claim 1, further comprising one or more black water tanks for storing water that has been used in providing beauty services to clients.

15. The mobile salon vehicle of claim 1, wherein the plumbing system includes one or more clean water tanks and one or more water pumps, the one or more water pumps to transfer water to cold water input pipe for one or more sinks in the mobile salon vehicle.

16. The mobile salon vehicle of claim 1, wherein the plumbing system includes one or more clean water tanks, one or more water pumps and one or more hot water heaters, the one or more water pumps to transfer water to the hot water heaters and the hot water heaters to heat the water.

17. The mobile salon vehicle of claim 16, wherein the hot water heater is connected to one or more hot water tanks, the one or more hot water tanks to store the hot water produced by the hot water heater.

18. The mobile salon vehicle of claim 17, wherein water is transferred from the one or more hot water tanks to hot water pipes of the sinks of the mobile salon vehicle.

19. The mobile salon vehicle of claim 17, further comprising a HVAC heat exchanger, the one or more hot water tanks to supply hot water to the HVAC heat exchanger to be utilized to operate the heating and air conditioning system.

20. The mobile salon vehicle of claim 1, wherein the engine and a diesel water heater heat up engine coolant to generate hot engine coolant which is used to provide hot water to one or more sinks in the mobile salon vehicle.
